(19) United States
(12) Patent Application Publication
(10) Pub. No.: US 2014/0300709 A1
(43) Pub. Date: Oct. 9, 2014

(54) DISPLAY DEVICE AND METHOD FOR REPRESENTING A THREE-DIMENSIONAL SCENE

(71) Applicant: SEEREAL TECHNOLOGIES S.A., Munsbach (LU)

(72) Inventors: Gerald Futterer, Dresden (DE); Ralf Haussler, Dresden (DE); Norbert Leister, Dresden (DE)

(21) Appl. No.: 14/352,713

(22) PCT Filed: Oct. 19, 2012
(86) PCT No.: PCT/DE2012/100323

§ 371 Date: Apr. 18, 2014

(30) Foreign Application Priority Data
Oct. 20, 2011 (DE) 10 2011 084 927.0

(51) Int. Cl. H04N 13/04

(52) U.S. Cl. CPC H04N 13/0404
USPC 348/51

(57) ABSTRACT

The invention relates to a display device for representing a three-dimensional scene, comprising a light source array, a lenticular system and a data display in this order, but not necessarily immediately following one another, and a corresponding method for representing a three-dimensional scene. The object thereof is to enlarge the observer region of a 3D display in such a way that this simultaneously provides a plurality of observers with the option of perceiving the 3D scene on the 3D display. This is achieved by an aforementioned display device with a multiplexing element, which follows the data display and can be used to distribute light incident from the data display into a plurality of angle segments, and by an aforementioned method, in which, in an additional step, a multiplexing element distributes the light coming from the data display in a plurality of angle segments.

The invention relates to a display device for representing a three-dimensional scene, comprising a light source array, a lenticular system and a data display in this order, but not necessarily immediately following one another, and a method for representing a three-dimensional scene.

Display devices for representing a three-dimensional scene, i.e. 3D displays, usually comprise a light source array, such as e.g. an illumination arrangement, also referred to as “backlight”, and a shutter display, i.e. a display with a switchable aperture effect, and also a lenticular system and a data display, for example a spatial light modulator (SLM), i.e. a display comprising cells or pixels, the transmission of light from the illumination arrangement of which is controllable. The lenticular system comprises a lens array, i.e. a lens matrix. Often, such a lens array is formed by cylindrical lenses arranged vertically next to one another, which focus light in the horizontal direction. However, e.g. a lens array comprising spherical lenses is also feasible. Moreover, they can comprise means for determining the visibility region or the visibility regions, wherein the visibility region refers to the region of the 3D display, in which an eye of an observer can perceive a view of the three-dimensional scene (3D scene).

Here, the light emanating from the light source array is deflected, polarized and modified in terms of amplitude and/or phase by the aforementioned optical elements and, optionally, by further optical elements in order finally to be projected onto the eyes of the observer in such a way that they can perceive a 3D scene.

Autostereoscopic 3D displays by the applicant, for representing a 3D scene, are known from e.g. WO 2005/027534 A2 and WO 2005/060270 A1. The sequence of the arrangement of the aforementioned components in the 3D display can correspond to the aforementioned itemized sequence. Autostereoscopic 3D displays, in the stereoscopic mode, project the light sequentially onto the eyes. Here, in a first step, only those cells, which are also referred to as “pixels”, on the shutter display are activated which illuminate the left-hand eye in a visibility region SPL, which is also referred to as a “sweet spot”, via the lenticular system. The data display shows the view of the 3D scene for the left-hand eye. Here, activating the pixels of the shutter display means that the corresponding pixels are switched to be transparent for the light impinging from the illumination arrangement. In the second step, only those pixels on the shutter display are activated which illuminate the right-hand eye in a visibility region SPR via the lenticular system. The data display shows the view of the 3D scene for the right-hand eye. These two steps are alternately repeated so quickly that the human visual faculty combines the two views to make a 3D view.

Here, the visibility regions SPL and SPR are tracked to the positions of the observer eyes of an observer by virtue of the positions of the observer eyes being determined and the corresponding pixels on the shutter display being activated depending on this position. This type of observer tracking is referred to as light source tracking. Visibility regions for additional observers are produced by virtue of additional pixels being activated on the shutter display.

For the purposes of observer tracking, i.e. by using the light source tracking, pixels on the shutter display, which do not lie on the optical axes of the lenses of the lenticular system, are also activated. These pixels are imaged in the visibility regions with aberrations. The aberrations can be so large that they lead to crosstalk from the left visibility region SPL into the right visibility region SPR, or vice versa.

There can likewise be crosstalk in the visibility regions of the additional observers. Thus, crosstalk means the impairment of a visibility region by light which actually belongs to a different visibility region.

These aberrations cannot be substantially reduced by optimizing the lenticular system. On the one hand, there is no fixed geometry, i.e. pixels of the shutter display at different positions are activated for the light source tracking. On the other hand, a multi-stage optical system, as is used, for example, in camera lenses, would be too expensive and too large or too voluminous.

Typically, in the usual use of a lenticular system comprising cylindrical lenses, the usable angle range of the light source tracking is restricted to approximately ±10° to ±15° with respect to the optical axes of these cylindrical lenses. This is an insufficient angle range, which results in an observer region that is too small for a 3D display which is to be employed for simultaneous display of a 3D scene for a plurality of observers. Here, the observer region is the region within which it is possible to place visibility regions.

Such problems described for autostereoscopic 3D displays can likewise occur in holographic 3D displays.

The present invention is therefore based on the object of specifying and developing a device and a method, by means of which the aforementioned problems are overcome. In particular, the observer region of a 3D display should be enlarged in such a way that it simultaneously provides a plurality of observers with the possibility of perceiving the 3D scene on the 3D display.

According to the invention, the object can be achieved by the teaching of patent claim 1. Further advantageous embodiments and developments of the invention emerge from the dependent claims.

According to the invention, a device of the type set forth at the outset, i.e. a display device for representing a three-dimensional scene, which is also referred to as 3D scene, which device comprises a light source array, a lenticular system and a data display in this order, but not necessarily immediately following one another, is characterized by a multiplexing element, which follows the data display and can be used to distribute light incident from the data display into a plurality of angle segments. In the following text, a display device for representing a three-dimensional scene is also referred to as 3D display.

Thus, according to the invention, a multiplexing element which can distribute the light into a plurality of angle segments is added to the elements of a conventional 3D display.

Here, a 3D display according to the invention can comprise an illumination arrangement and a shutter display as light source array. The illumination arrangement for this can have very different configurations: it may comprise a single large-area homogeneous light source or a multiplicity of individual light sources, which lead to a homogeneous light wave field. The light emitted by these light sources then impinges on the shutter display. The shutter display is a transmission display which is switchable pixel-by-pixel: the light emitted by the illumination arrangement passes the activated pixels, whereas non-activated pixels block the light.

However, a 3D display according to the invention can also comprise a light source array with a self-luminous display. The latter can be realized by an OLED display, in which light sources or individual pixels are activated at the appropriate positions. An OLED display is advantageous for the energy efficiency of the 3D display. Therefore, it is possible to dispense with the illumination arrangement and the shutter display when using an OLED display as light source array.

Here, such a 3D display according to the invention can comprise means for determining a visibility region. Then, within an angle segment, the visibility regions are made to track the observers by means of light source tracking. The whole observer region obtainable thereby is composed of the angle segments, which are also referred to as individual observer regions in the following text, and is enlarged compared to an individual angle segment. Here, the size of the central angle segment corresponds to the observer region, which can be obtained with a 3D display according to the prior art; thus, the additional angle segments obtained by utilizing the multiplexing element correspondingly enlarge the overall observer region.

Compared to other options of enlarging the observer region, this solution is simpler and only requires already tested components.

According to the invention, the display device for representing a three-dimensional scene can comprise an autostereoscopic 3D display. Alternatively, it can comprise a holographic 3D display, wherein the enlargement of the observer region is suitable, in particular, for a holographic 3D display with 1D encoding in the vertical direction, as described in WO2006/119920 A1.

In a 3D display according to the invention, a field lens could moreover be arranged following the multiplexing element or between the lenticular system and data display. This would improve the homogeneity over the display area and additionally enlarge the observer region.

Furthermore, the 3D display according to the invention can comprise a data display, which comprises a multiplicity of pixels, and comprise a multiplexing element, which comprises segments and, in the process, is configured in such a way that the segments of the multiplexing element are matched to the pixels of the data display. Here, the size of the segments of the multiplexing element can be matched to the size of the pixels of the data display, for example equal a multiple of the pixel size of the data display. Moreover, the position of the segments of the multiplexing element can be aligned with respect to the position of the pixels of the data display.

Moreover, in a 3D display according to the invention, the data display can comprise color filters for the primary colors, such as e.g. for red, green and blue colors, arranged pixel-by-pixel, wherein, in that case, the segments of the multiplexing element corresponding thereto should each be designed to refract in a wavelength-dependent manner.

The multiplexing element of a 3D display according to the invention could moreover comprise a prism mask, which comprises a row-by-row and/or column-by-column periodic arrangement of prism segments.

The prism segments of the prism mask of the multiplexing element can in turn comprise a plurality of refractive surfaces with different refractive powers (different refractive indices), arranged at an angle greater than 0° and less than 90° with respect to the optical axis. Advantageously, the surface with the highest refractive power should be situated on the light-output side.

Here, in order to obtain a color display in a 3D display according to the invention, the data display can comprise color filters for the primary colors, arranged pixel-by-pixel, and the corresponding prism segments of the prism mask can comprise prism angles adapted to their wavelength-dependent refractive index.

A 3D display according to the invention can also comprise an arrangement of light-polarizing elements. Such an arrangement of light-polarizing elements could be linked to at least two of the following three elements: light source array, lenticular system and data display. Specifically, the arrangement of light-polarizing elements could comprise structured polarization filters and/or structured retardation elements.

Here, the structured polarization filters and/or structured retardation elements are advantageously arranged and designed in such a way that crosstalk is largely avoidable. In the case of crosstalk, one eye of the observer receives components of the image intended for the other eye of the observer or else for other observers.

The structured retardation elements can comprise birefringent and/or polarization-rotating regions. Optionally, such a polarizing element can also be configured in such a way that a plurality of polarizing sub-elements and/or partial-retardation elements are arranged one above the other.

It is also advantageous if the birefringence of structured retardation elements is symmetrized, since the chromatic aberrations increase with increasing refractive power or increasing birefringence.

In a further advantageous embodiment, the 3D display comprises at least one apodization means. Here, this apodization means can comprise a grayscale distribution or a color distribution separated into red/green/blue or a spatial distribution of the polarization state. Advantageously, it is implemented in the data display.

It is likewise advantageous if the data display, which comprises a large number of pixels, comprises non-illuminated transition regions between the pixels of the data display.

Additionally, in a 3D display according to the invention, the observer region can furthermore be enlarged by an additional, controllable deflection element that is introduced into the beam path. This deflection element can be a switchable grating, as described in WO2010/149587 A2, which can for example be based on liquid crystals, switchable volume gratings or on electro-wetting, as described in WO2010/066700 A2. For the control thereof, it comprises transparent electrodes. It is also possible to employ switchable liquid crystal surface relief gratings and transparent electrodes in a controllable deflection element. A controllable deflection element can comprise switchable liquid crystal polarization gratings as switchable retardation plates as a further option.

In order to achieve improved illumination of the lenticular system, optical elements are arranged on the light-output side of the light source array in an advantageous embodiment of the display device (3D display) according to the invention. Said optical elements are configured in such a way that they guide the light from the light source array in each case to the center of a lens of the lenticular system.

Such optical elements can comprise lenses or be realized by lenses, the focal length of which corresponds approximately to the distance between the light source array and the lenticular system.

Such optical elements can also comprise prisms.

There can also be interfering crosstalk during the transmission of the light through the multiplexing element, for example at the transitions between individual segments of the multiplexing element, such as e.g. at the transitions of the prism segments of the prism mask used in one embodiment. It is therefore advantageous to arrange an aperture arrangement in front of or directly behind the multiplexing element.

By contrast, microlenses in front of the multiplexing element can advantageously increase the transmission through the multiplexing element. Also, the use of microlenses in front of the multiplexing element may optionally prevent the illumination of the transitions between individual segments of the multiplexing element.

In terms of the method, the object set forth at the outset can be achieved by the features of claim 32. According thereto, a method for representing a three-dimensional scene, wherein light is emitted from a light source array depending on a visibility region defined by the position of an observer, guided through a lenticular system onto a data display, the data display controlling the transmission of this light in terms of phase and/or amplitude in a pixel-by-pixel manner and the light modified thereby finally being perceived by an observer in visibility regions assigned to his eyes, is characterized in that a multiplexing element distributes the light coming from the data display in a plurality of angle segments. Here, the observer region achievable overall is composed of the individual angle segments and is enlarged compared to a method in the prior art, in which the light would correspondingly only be distributed in a single angle segment.

Here, in the method according to the invention, the light source array can comprise an illumination arrangement, from which a homogeneous light wave field emerges and subsequently passes activated pixels of a shutter display depending on a visibility region defined by the position of an observer.

On the other hand, in the method according to the invention, the light source array can comprise a self-luminous display, in particular an OLED display. Here, light is emitted from activated pixels of this display depending on a visibility region defined by the position of an observer. Passage through a controllable shutter display is not required in this case since the control is already performed by activating pixels of the self-luminous display.

Here, in a method according to the invention, the light can advantageously be sequentially guided to the individual angle segments, wherein always only one angle segment is illuminated at any one time. This can avoid crosstalk in visibility regions of the other eye or of other observers.

In a method according to the invention, it is also possible for the visibility region within one angle segment to be tracked by means of light source tracking. This tracking of the visibility region within an angle segment could be performed sequential in time.

Moreover, in a method according to the invention, the light can pass through a field lens on its path from the light source array to the observer.

In a method according to the invention, it is also possible, in pre-definable spatial regions, for light to experience a change in the polarity thereof on the path from the light source array to the observer.

Furthermore, it is advantageous if there is apodization, i.e. optical filtering, which increases the contrast of the image visible in the observer eye within the scope of the method according to the invention. This can be sequential in time for different eye positions.

Moreover, in a method according to the invention, the light could additionally be deflected by a controllable deflection element that can be introduced into the beam path.

Such an additional deflection can be produced by the targeted reorientation of liquid crystals contained for this purpose in a volume grating or in a liquid crystal surface relief grating or in a liquid crystal polarization grating, which liquid crystals are part of a controllable deflection element.

There are now various options for configuring and developing the teaching of the present invention in an advantageous manner and/or for combining the above-described embodiments with one another to the extent that this is possible. To this end, reference should be made, firstly, to the patent claims depending on patent claim 1 or patent claim 32, and, secondly, to the following explanation of the preferred exemplary embodiments of the invention on the basis of the drawings. Preferred embodiments and developments of the teaching are also explained in general terms in conjunction with the explanation of the preferred exemplary embodiments of the invention on the basis of the drawing.

In detail:

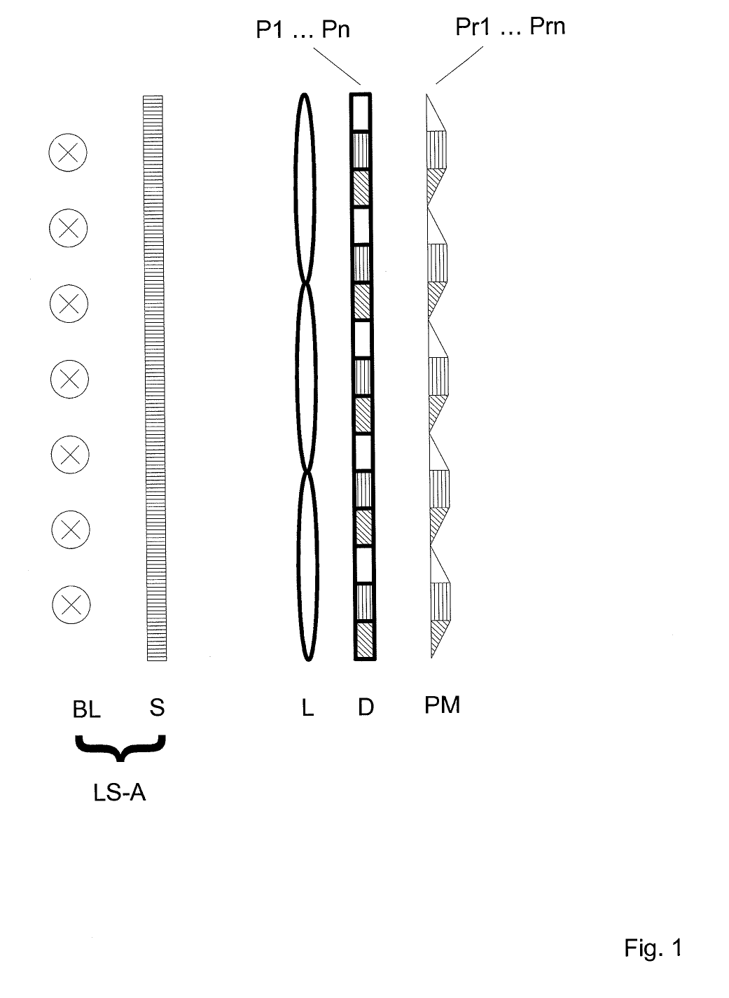

FIG. 1 shows a top view of an embodiment of part of a 3D display according to the invention.

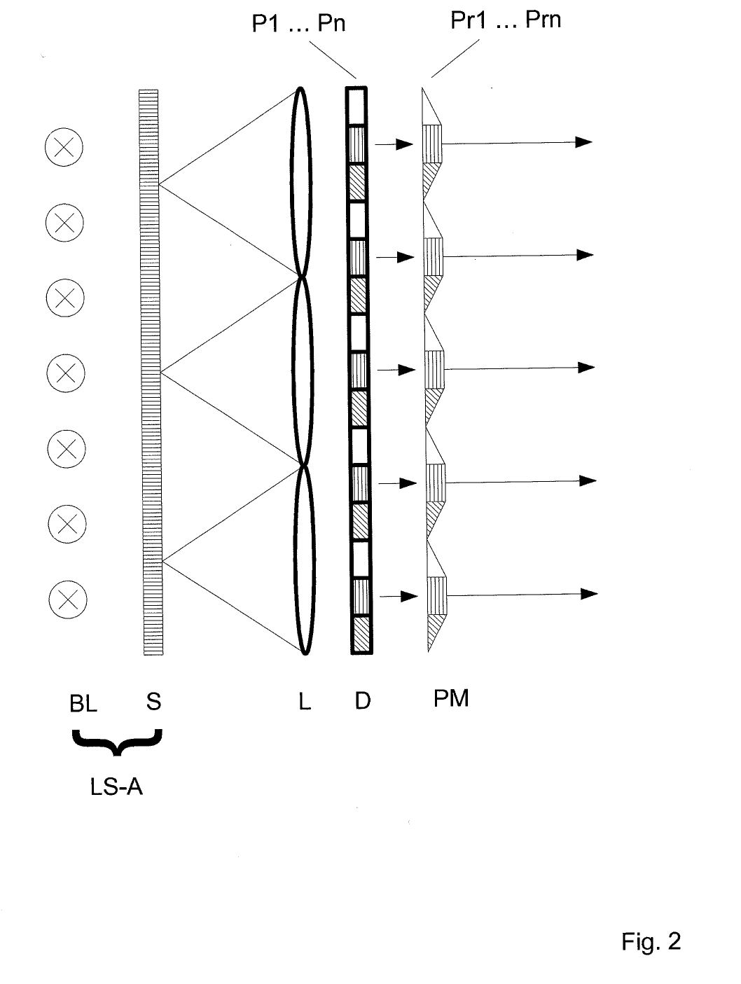

FIGS. 2 to 7 show the generation of different visibility regions.

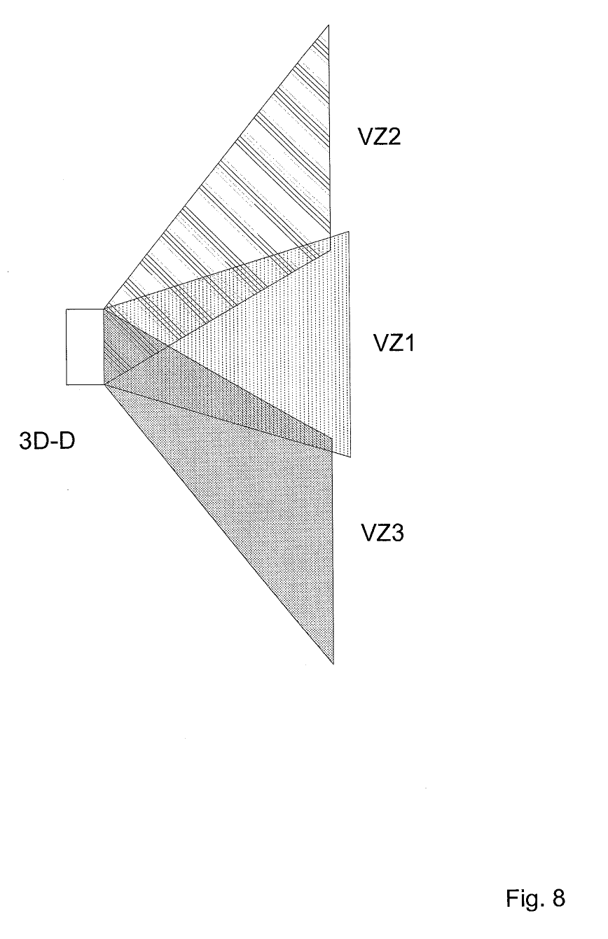

FIG. 8 shows the generation of an overall observer region from individual observer regions.

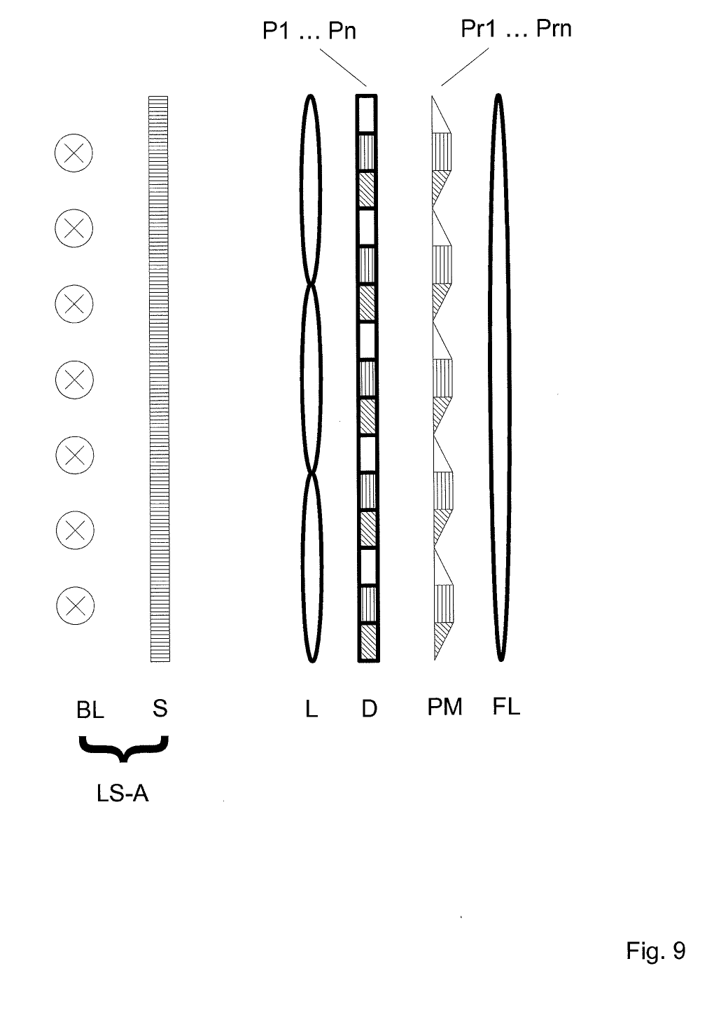

FIG. 9 shows an embodiment of a 3D display according to the invention, with an additional field lens behind the prism mask in the light direction.

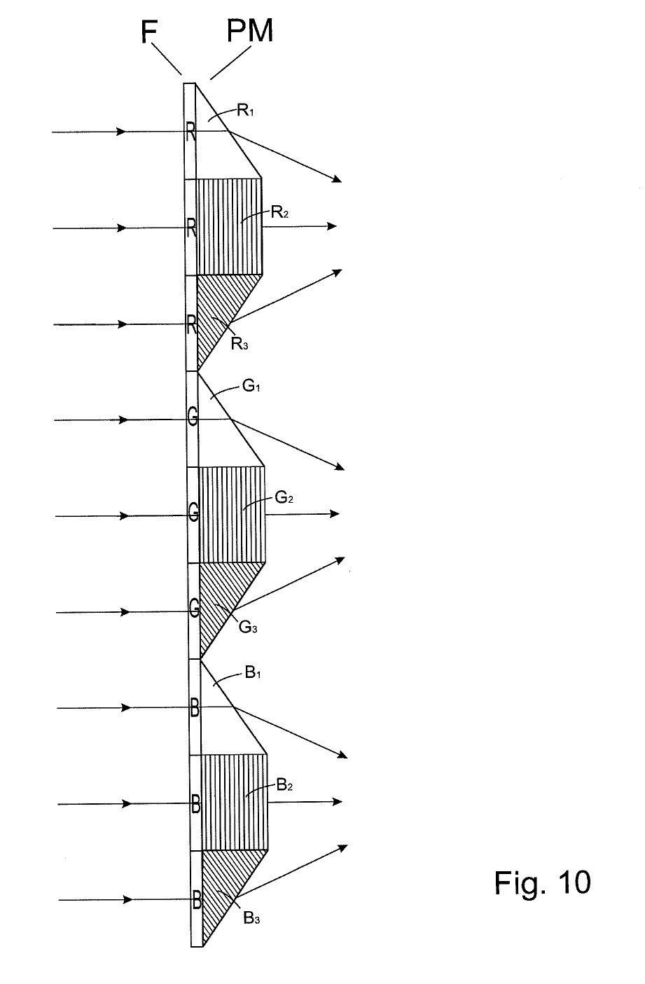

FIG. 10 shows an embodiment, in which the data display has color filters for simultaneous display of the primary colors red, green and blue.

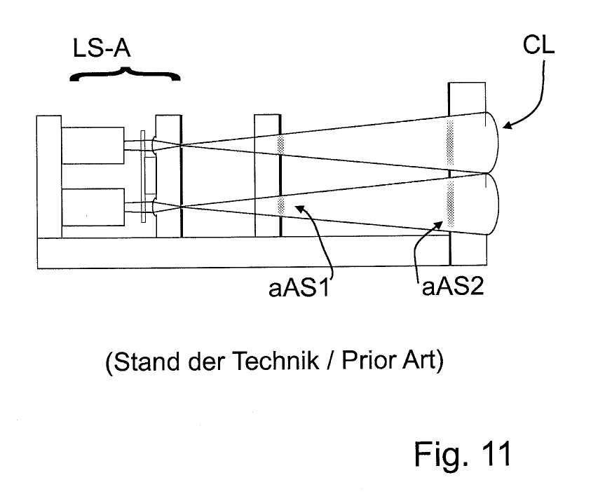

FIG. 11 shows an embodiment for suppressing crosstalk according to the prior art.

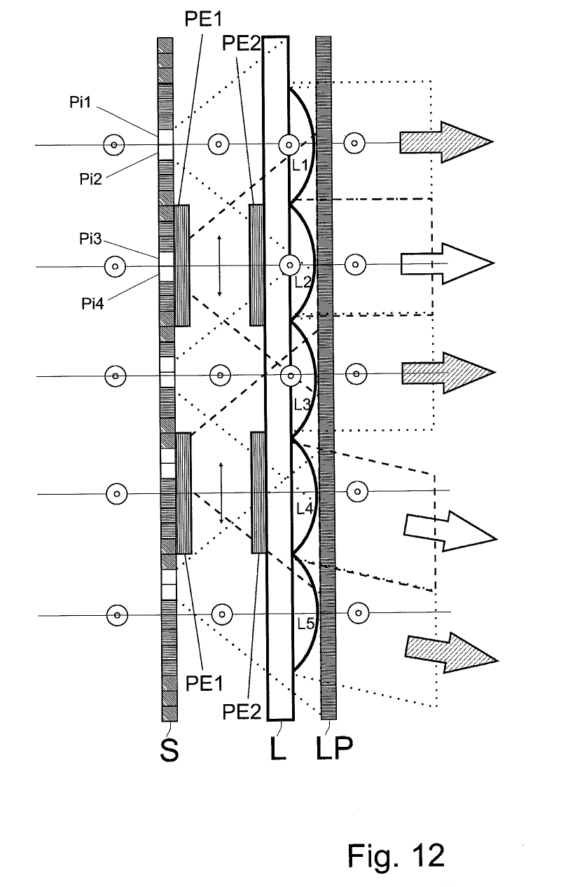

FIG. 12 shows a section of the arrangement from FIG. 1 with an embodiment comprising polarizing elements for suppressing crosstalk.

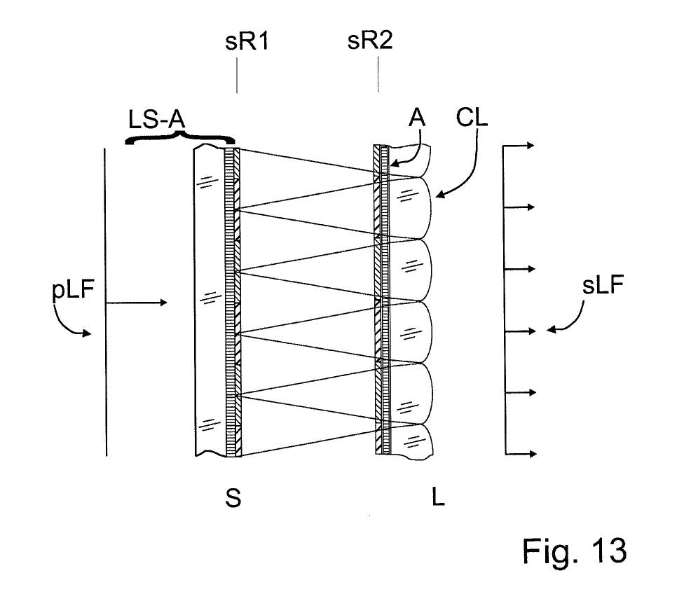

FIG. 13 shows a section of the arrangement from FIG. 1 with an embodiment comprising structured retardation elements for suppressing crosstalk.

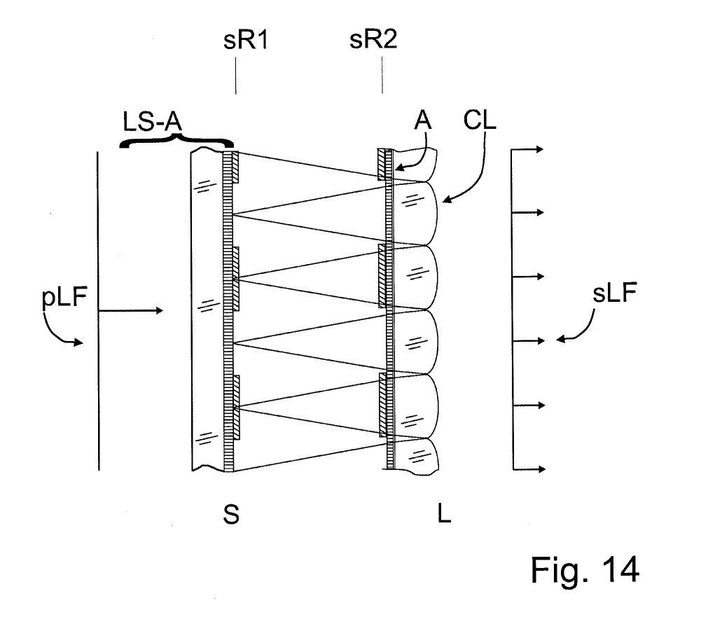

FIG. 14 shows a section of the arrangement from FIG. 1 with an embodiment using structured retardation elements for suppressing crosstalk, in which, however, respectively two such retardation elements are situated one behind the other in the light path in front of only every second cylindrical lens.

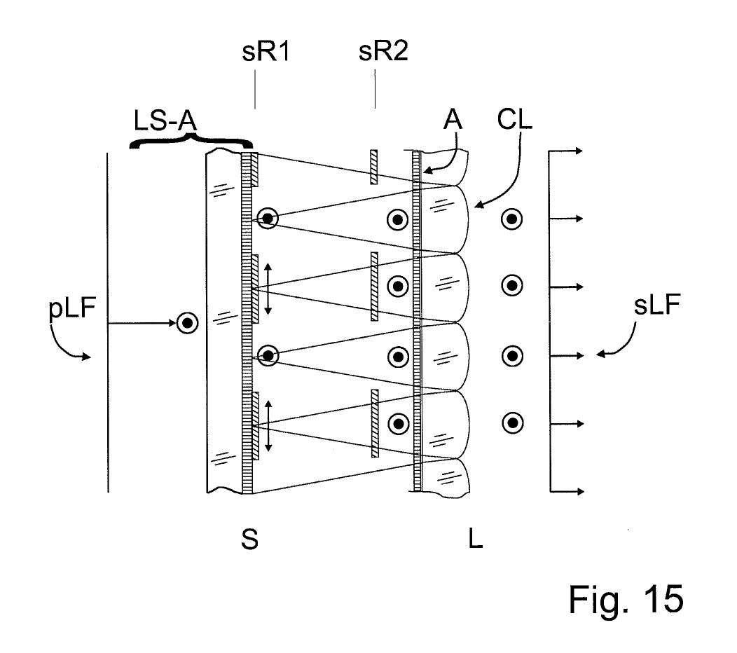

FIG. 15 shows a section of the arrangement from FIG. 1 with an embodiment comprising structured retardation elements for suppressing crosstalk in front of every second cylindrical lens, with a polarization sequence.

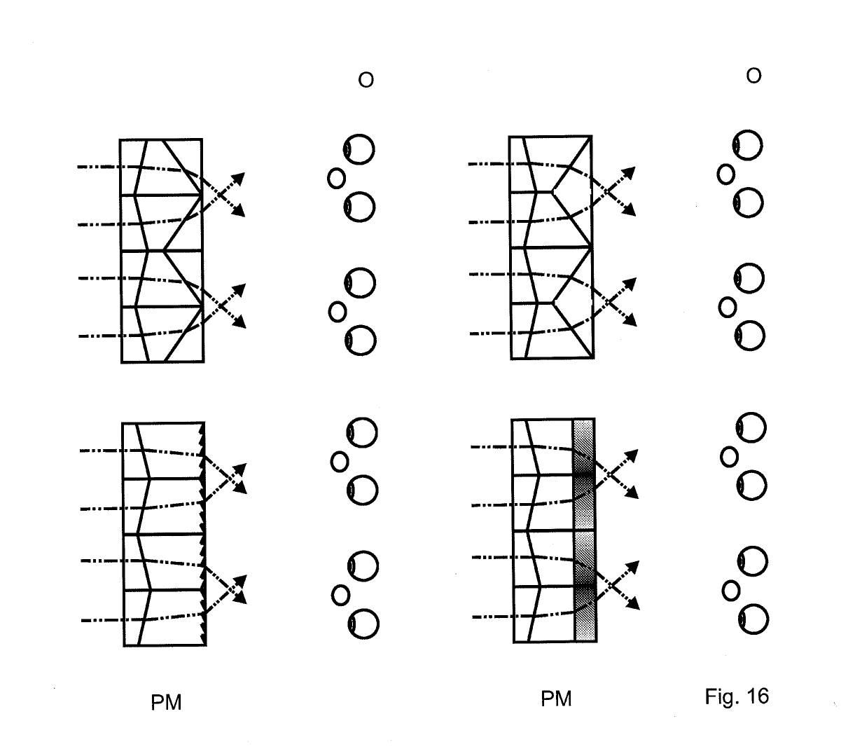

FIG. 16 shows implementation examples of fixed solid angle multiplexing prism structures.

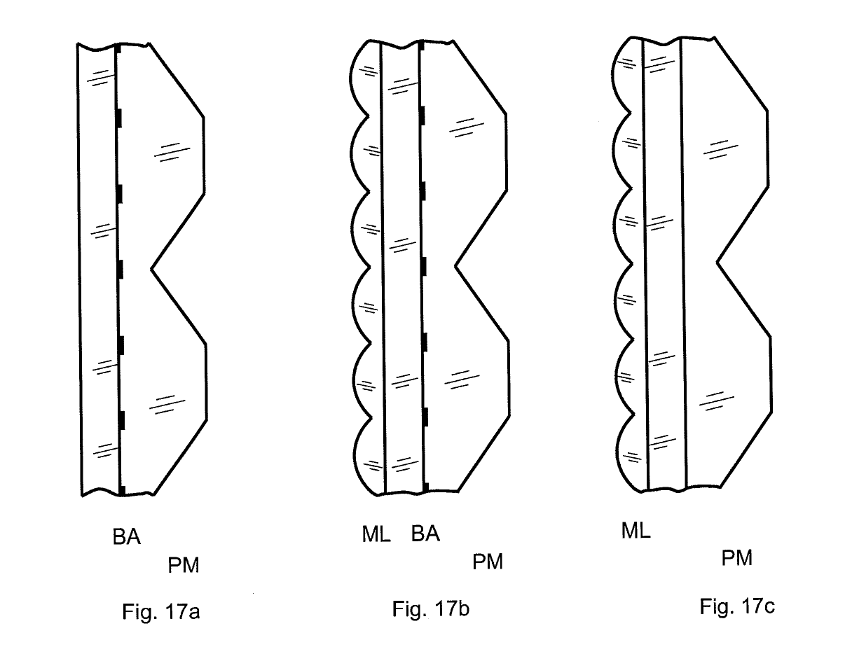

FIGS. 17a-c show a section of the arrangement from FIG. 1 with an embodiment in which amplitude aperture masks and microlenses are used directly in front of the transitions of the multiplexing prisms.

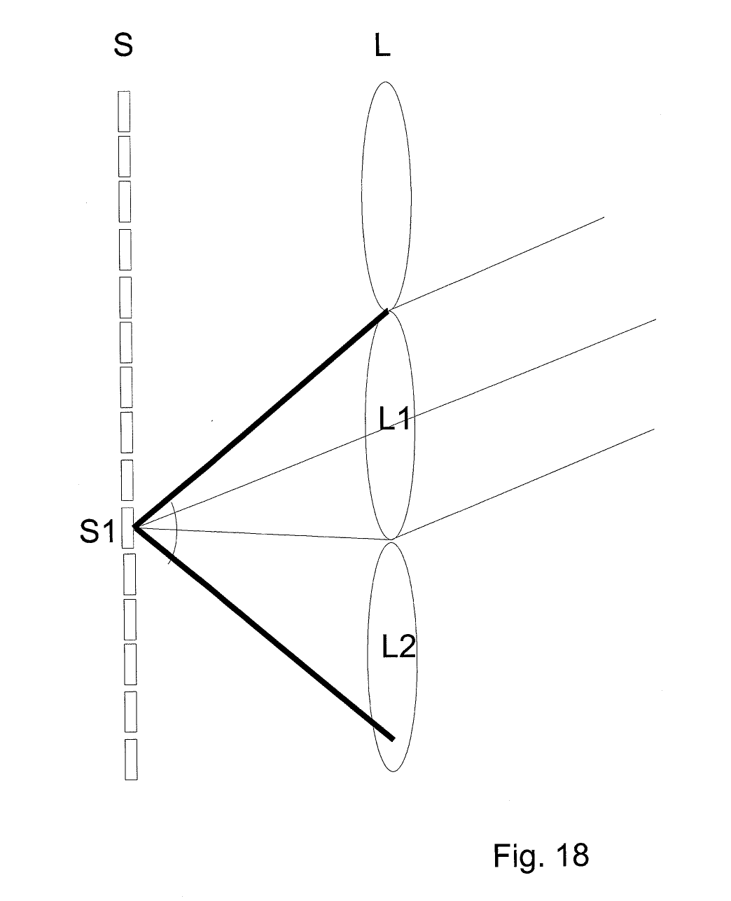

FIG. 18 shows the emission angle of a shutter opening of the shutter display, which is laterally displaced with respect to the optical axis of a lens of the lenticular system.

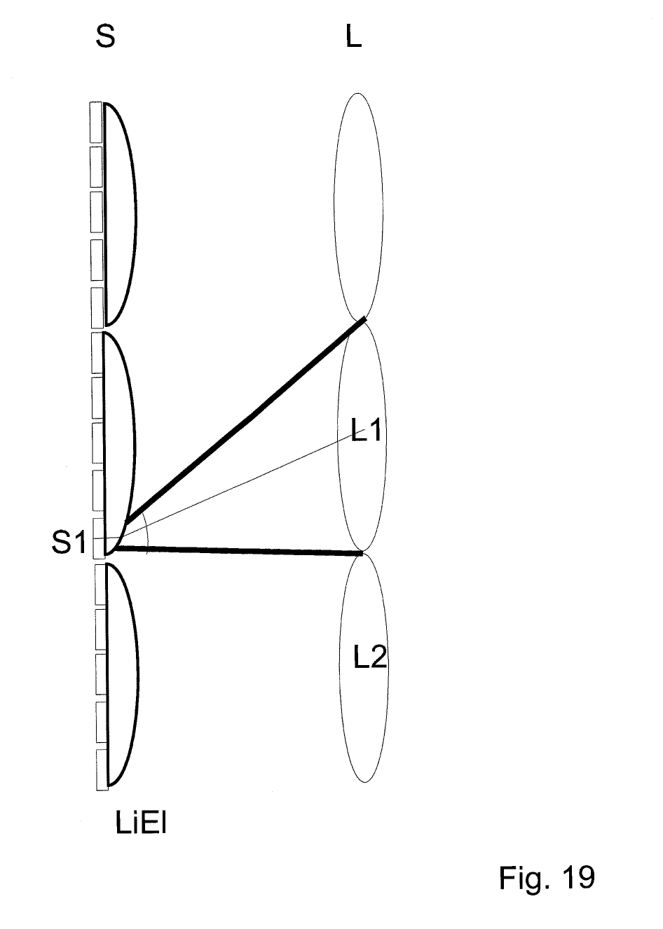

FIG. 19 shows the use of additional lenses in front of the shutter openings of a shutter display.

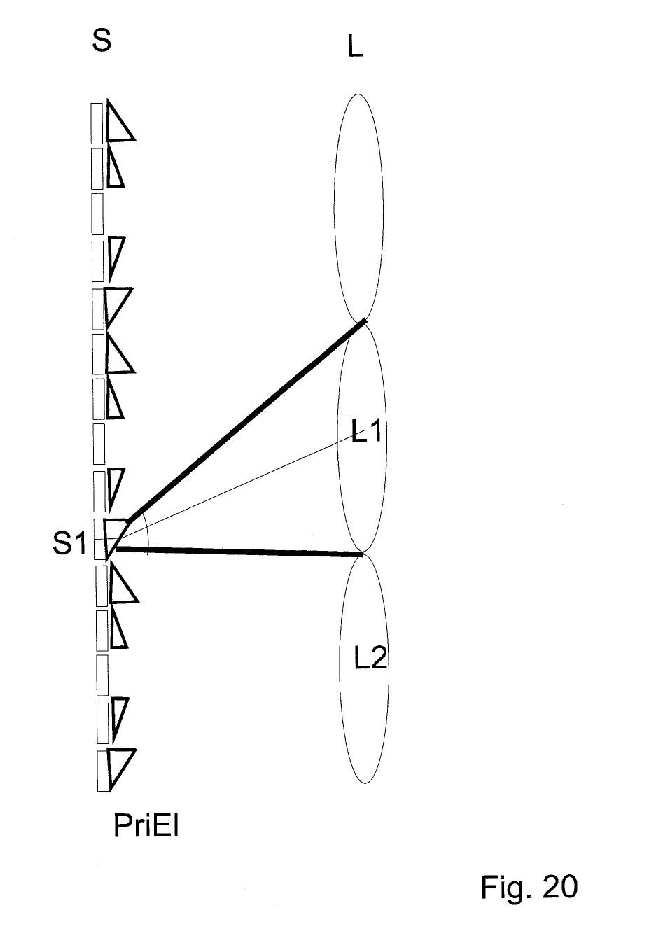

FIG. 20 shows the use of additional prism elements in front of the shutter openings of a shutter display.

In a number of the application examples, the invention will be explained in an exemplary manner on the basis of a multiplexing element comprising prism frustums and generating three angle segments. However, other multiplexing elements, other “shapes” and a different number of angle segments also fall within the scope of this invention.

In a top view, FIG. 1 schematically shows an embodiment of part of a 3D display according to the invention. An illumination arrangement BL illuminates a shutter display S. The illumination arrangement BL can comprise LEDs, lasers or other suitable light sources. A shutter display S comprises cells, the transmission of which is controllable, for example a liquid crystal display with pixels, by means of which the amplitude and/or the phase of the light of the illumination arrangement BL is controllable. A lenticular system L comprises cylindrical lenses arranged next to one another. In this embodiment, the distance between the shutter display S and the lenticular system L is determined by the focal length of the cylindrical lenses. As an alternative to the cylindrical lenses, it is possible to use a lens array made of spherical lenses. A data display D comprises cells, the transmission of which is controllable, such as e.g. a liquid crystal display with pixels, by means of which the amplitude and/or the phase of the light of the illumination arrangement BL is controllable. In particular, controlling the phase by a pixel should be understood to mean setting or varying the optical path of the light through this pixel. Therefore, it is possible to set the optical paths individually for different pixels. The cells or pixels are denoted by P1, P2, . . . Pn. A prism mask PM comprises prism frustums, the segments of which are denoted by Pr1, Pr2, . . . Prn. The pixels P1, P2, . . . Pn of the data display D are optically and/or mechanically directly assigned to the prism segments Pr1, Pr2, . . . Prn of the prism mask PM.

FIG. 2 shows how the 3D display described in FIG. 1 can be used to generate a visibility region (not displayed here) positioned centrally in front of the display. The pixels situated substantially on the optical axes of the lenses of the lenticular system L are activated in the shutter display S. The light emanating from these pixels impinges on the data display D in a collimated and substantially perpendicular manner behind the lenticular system L. In the data display D, only the pixels P2, P5, P8, . . . are activated and described with the content assigned to the position of this visibility region. The light transmitted thereby passes through the plane parallel prism segments Pr2, Pr5, Pr8, . . . , which are depicted here with straight-line shading, and it is not deflected in the process. A visibility region positioned centrally in front of the display is generated.

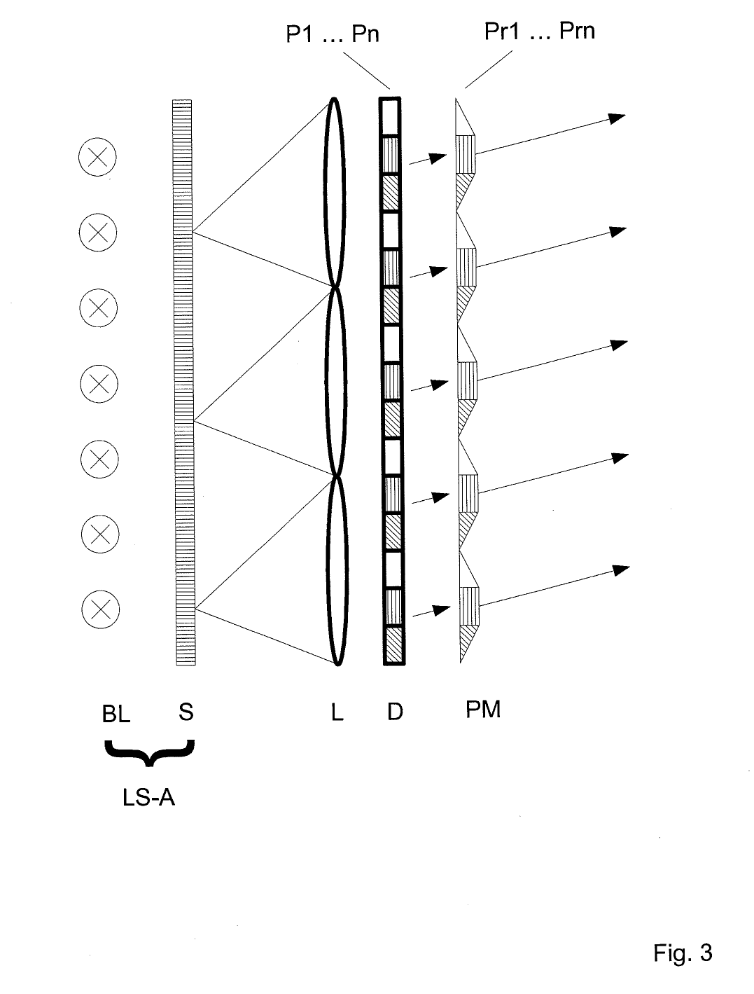

FIG. 3 shows how the light source tracking is used for a small tracking angle, for example in the range up to ±10°. Pixels with positions situated next to the optical axes of the cylindrical lenses of the lenticular system L are activated in the shutter display S. The light passes through the data display D at an angle and forms a visibility region which is not positioned centrally in front of the 3D display. In the data display D, it is still only the pixels P2, P5, P8, . . . that are activated and described with the content assigned to the position of this visibility region. The light transmitted thereby passes through the plane parallel prism segments Pr2, Pr5, Pr8, . . . and it is not deflected in the process.

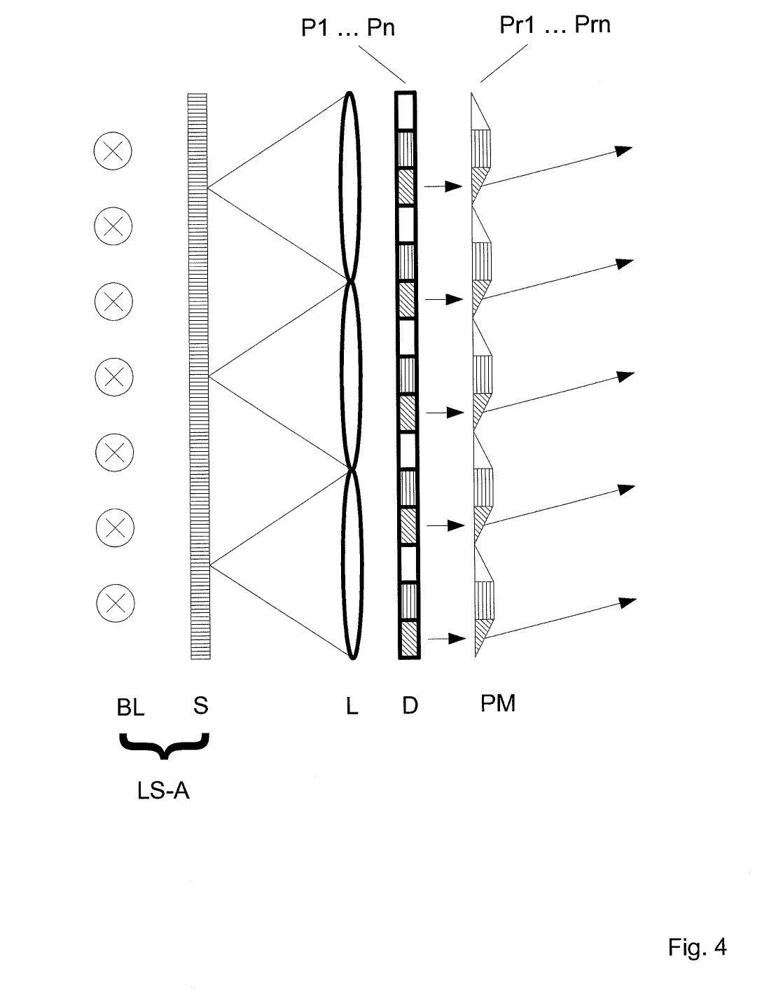

FIG. 4 now shows, in an exemplary manner, how the prism mask PM is used according to the invention for enlarging the observer region. The pixels situated substantially on the optical axes of the lenses of the lenticular system L are activated in the shutter display S. The light emanating from these pixels impinges substantially perpendicularly on the data display D. In the data display D, the pixels P3, P6, P9, . . . are now activated, after which the light passes through the assigned prism segments Pr3, Pr6, Pr9, . . . , which are depicted here with angled shading. In the process, the light is deflected and generates a visibility region which is not positioned centrally in front of the 3D display.

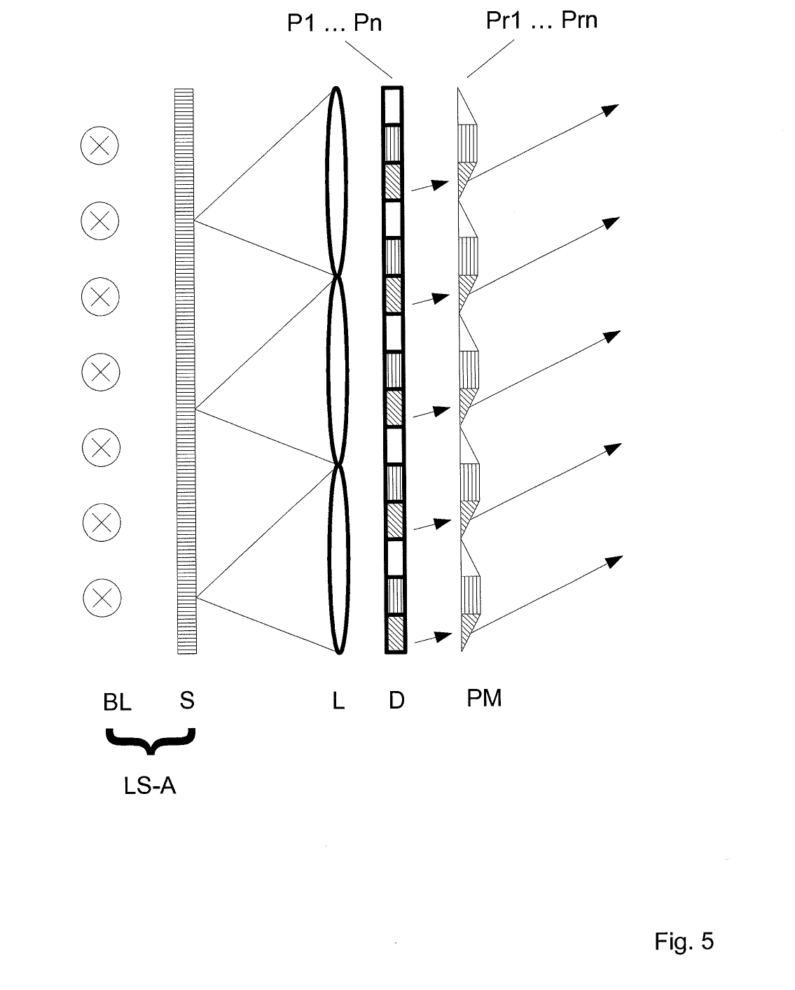

FIG. 5 shows how the visibility region is deflected even further from a non-central position by means of light source tracking. Pixels situated next to the optical axes of the lenses of the lenticular system L are now activated in the shutter display S. The light passes through the data display D at an angle and it is once again deflected by the prism segments Pr3, Pr6, Pr9, . . . , which are depicted here with angled shading. The overall deflection of the light is composed of the light deflection by the light source tracking and the light deflection in the prism segments Pr3, Pr6, Pr9, . . . and it is enlarged compared to pure light source tracking.

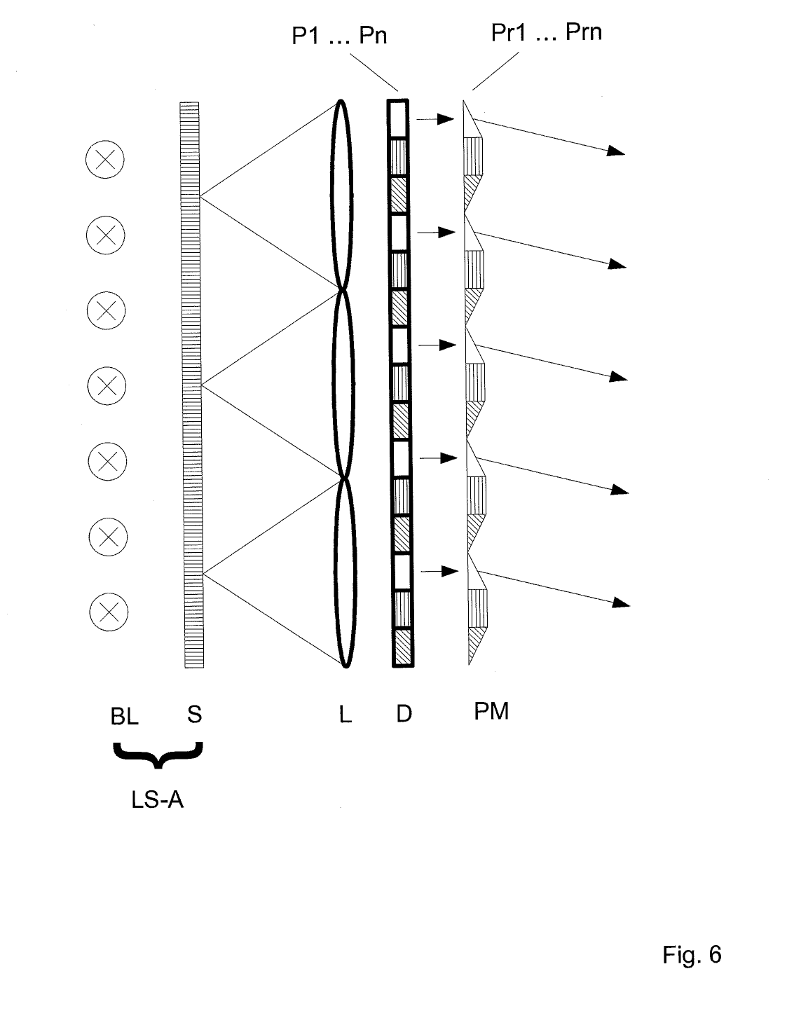

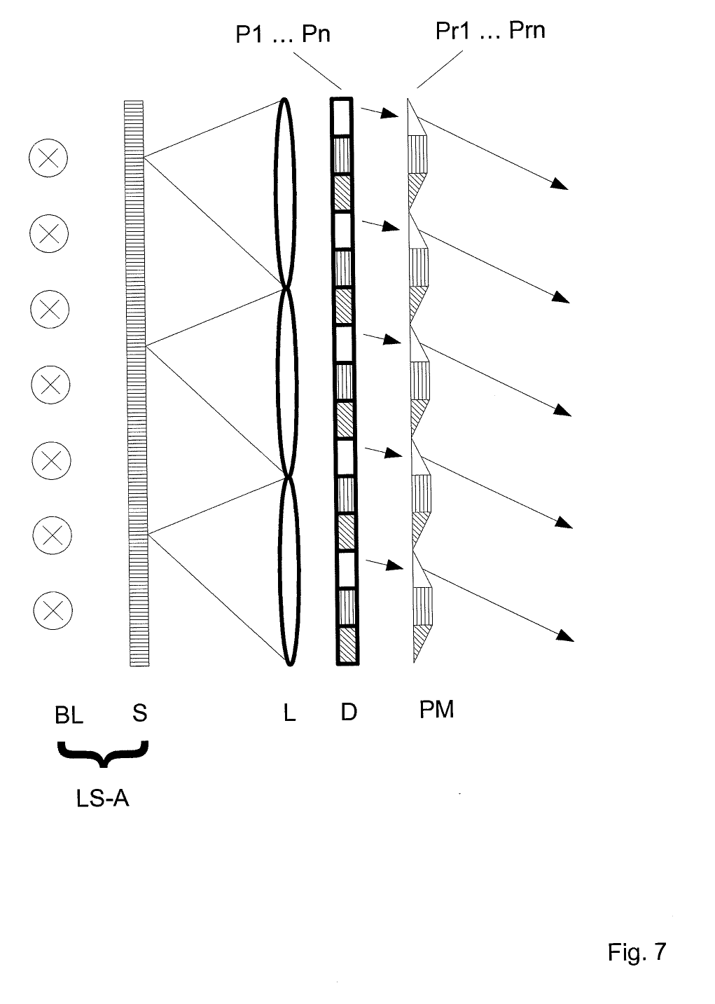

FIG. 6 and FIG. 7 show how, analogous to the descriptions in respect of FIG. 4 and FIG. 5, a greater light deflection is obtained in the other direction using the prism segments Pr1, Pr4, Pr7, . . .

FIG. 8 shows how, according to the invention, an enlarged overall observer region of a 3D display 3D-D is obtained. In the central individual observer region VZ1, use is made of the plane parallel prism segments Pr2, Pr5, Pr8, . . . in conjunction with the light source tracking. In the two lateral individual observer regions VZ2 and VZ3, use is made of the angled prism segments Pr1, Pr4, Pr7, . . . or Pr3, Pr6, Pr9, . . . . Within an individual observer region VZ1, VZ2 or VZ3, the visibility regions are tracked continuously by means of light source tracking. The tracking in the individual observer regions VZ1, VZ2 or VZ3 is sequential, i.e. always only one of the pixel groups P1, P4, P7 . . . , P2, P5, P8, . . . or P3, P6, P9, . . . is activated at any one time. This is important so as to avoid crosstalk in other visibility regions.

The individual observer regions VZ1, VZ2 and VZ3 must adjoin one another without gaps in order to ensure continuous tracking of the visibility regions. A small overlap between the individual observer regions VZ1, VZ2 and VZ3 is advantageous for compensating tolerances and enabling an unnoticeable transition into an adjacent individual observer region.

Values for a 3D display which comprises a prism mask PM with a prism angle α for a prism segment (depicted in FIG. 1) of 30° are now listed in an exemplary manner. The light source tracking with the aid of the shutter display S and the lenticular system L is possible in the angle range from −10° to +10°, as measured from the normal of the lenticular system substrate. The refractive index of the prism mask PM is 1.5.

In this example, the light guided through the central prism segments Pr2, Pr5, Pr8, . . . covers the angle range from −10° to +10°. The light guided through the outer prism segments Pr1, Pr4, Pr7, . . . covers the angle range from −33° to −7°; the light guided through the outer prism segments Pr3, Pr6, Pr9, . . . covers the angle range from +7° to +33°. The overall angle range of the 3D display is composed of these individual angle ranges and is −33° to +33° relative to the normal of the data display D. Consequently, compared to a 3D display without prism mask PM, the angle range and therefore the overall observer region is increased approximately threefold. The overlap of the angle region is 3° and provides sufficient tolerance for tracking the visibility regions.

In the described exemplary embodiments, work is undertaken with a prism mask PM comprising prisms of three different prism segments Pr1, . . . Prn in a periodic arrangement. This leads to a three-fold increase in the overall observer region. Other embodiments are possible, for example with a prism mask PM which comprises prisms of two different prism segments Pr1, . . . Prn in a periodic arrangement and leads to a two-fold increase in the observer region. Likewise, prism masks PM comprising periodic arrangements of prisms of more than three different prism segments Pr1, . . . Prn are possible.

In the application examples highlighted here, the invention is explained on the basis of the increase in the horizontal observer region using light source tracking, as described in e.g. DE 10 2011 005 154 A1, in the horizontal direction and prism masks PM which deflect light in the horizontal direction. However, the arrangement can also be rotated by 90° such that the vertical observer region can be enlarged in the case of light source tracking in the vertical direction. Likewise, two-dimensional light source tracking with enlargement of the observer region in the horizontal and vertical direction is possible. To this end, use is made of a lens array which is periodic in two dimensions and a prism mask PM which is periodic in two dimensions.

FIG. 9 shows a further embodiment of a 3D display according to the invention, with an additional field lens FL, which is preferably attached behind the prism mask PM in the light direction. The focal length of said field lens preferably corresponds to the nominal observer distance, for example 3 m for a 3D TV. The field lens ensures that the light passes perpendicularly through the data display D and the prism mask PM for an observer O at the nominal observer distance and centrally in front of the 3D display. The field lens FL therefore improves the homogeneity over the display area and enlarges the observer region. In FIG. 9 described here, the components of a 3D display according to the invention, with an additional field lens, are depicted in the sequence: lenticular system L, data display D, prism mask PM and field lens FL. This sequence is advantageous for a number of reasons: after the lenticular system L, the light passes through all pixels P1, P2 . . . Pn of the data display D at the same angle. This is advantageous for the homogeneity of the light modulation over the display area. Moreover, the light impinges at the same angle on the prism mask PM behind the pixels P1, P2 . . . Pn of the data display D. This is advantageous for homogeneous light deflection in the prism segments Pr1, Pr4, Pr7, . . . , Pr2, Pr5, Pr8, . . . and Pr3, Pr6, Pr9, . . . and, as seen from a visibility region, leads to a homogeneous brightness of the 3D display. However, other sequences are possible, such as arranging the field lens FL between lenticular system L and data display D, for example.

In a further application example, shown in FIG. 10, a data display D has color filters for simultaneous display of the primary colors red R, green G and blue B. In order to avoid dispersion effects in the visibility regions, it is advantageous to arrange the color filter on the data display D or between data display D and prism mask PM in the scheme of the periodicity of the prism mask PM. For a prism mask PM from the example in FIG. 1, this corresponds to an arrangement with the sequence RRRGGGBBB, i.e. pixels P1-P3 are provided with red color filters R, pixels P4-P6 are provided with green color filters G, pixels P7-P9 are provided with blue color filters B, and so on. The dispersion of the optical medium of the prism mask PM, made, for example, from polymethylmethacrylate (PMMA), is compensated by virtue of the prism angles being adapted to the wavelength-dependent refractive index of the optical medium. The prism frustum Pr1-Pr3 therefore has a different prism angle than the prism frustums Pr4-Pr6 or Pr7-Pr9, etc. (not depicted in FIG. 10).

If lenticular systems L are used for segment-by-segment collimation in an autostereoscopic display, as is known e.g. from WO 2005/027534 A2 or WO 2005/060270 A1, it is possible, as already described above, for light also to reach a neighboring lens not intended for collimating this light. This is referred to as crosstalk.

In static embodiments, crosstalk can be suppressed by one or more fixed aperture fields. These aperture fields can also be apodized, in particular within the meaning of WO 2009/156191 A1. This is depicted in FIG. 11.

However, fixed aperture fields are not suitable for suppressing crosstalk when using light source tracking.

By contrast, the use of strip-shaped polarizers, as described in DE 10 2006 033 548 A1, is suitable for suppressing crosstalk when using light source tracking. A problem here can be that light is blocked at the polarizers. Insufficient efficiency or an insufficient light yield increases the costs of the light source and the costs of operation.

Fixed aperture fields are known for suppressing crosstalk in collimation units. DE 10 2006 033 548 A1 describes effective suppression of crosstalk using polarization filters if light source tracking is used, which polarization filters are arranged in a strip-shaped manner, which are also referred to as polarization films or analyzers.

FIG. 12 shows a further application example, in which polarizing elements PE1, PE2 are introduced into a section of the arrangement from FIG. 1. Said polarizing elements serve to prevent crosstalk into other visibility regions in an even more effective manner: therefore, it is intended to prevent light, which should only pass through one lens of the lenticular system L for collimation purposes, from passing through a different lens of the lenticular system L. The light emanating from pixels of the shutter display S impinges not only on the lens of the lenticular system L arranged directly therebehind, but also on adjacent lenses. This light can lead to crosstalk in other visibility regions. Polarizing elements, which are fastened to the shutter display S, the lenticular system L and/or the data display D, prevent crosstalk into the adjacent lens. Light substantially only passes through the lens provided for the collimation of the light and, possibly, to a lesser extent through the next lens but one, but not through the lens adjacent to the lens provided for collimating the light. There are a number of possible combinations for arranging such polarizing elements and for embodying the polarizing elements, of which two examples are mentioned in the following text:

In the first example (not depicted here), the lenticular system L is provided with a structured polarization filter. The polarization direction of the light transmitted through adjacent lenses is alternately aligned e.g. horizontally and vertically. In this example, the shutter display S has pixels with section-by-section or pixel-by-pixel alternating horizontal and vertical polarization directions of the transmitted light. The polarization direction can change in the direction of columns or rows. By activating the corresponding pixels of the shutter display S, it is possible to control through which lenses of the lenticular system L the light passes. In this respect, the first example corresponds to the concept of the arrangement known from WO 2008/009586 A1.

In the second example, depicted in FIG. 12, use is made of structured retardation elements, in this case structured retardation films, on the shutter display S and the lenticular system L in order to rotate the polarization direction of the light. The retardation films on the shutter display S need not be structured in a pixel-by-pixel manner. Rather, they can have the same grid dimensions as the lenticular system. Therefore, the light can substantially only pass through the lenses of the lenticular system L which lie opposite the pixels of the shutter display S, and not through adjacent lenses. This embodiment has a higher light efficiency than the embodiment described above.

In the following text, the mode of operation of the arrangements shown in FIG. 12 is described: the light coming from the left-hand side of the illumination arrangement BL (not shown in FIG. 12) is linearly polarized—perpendicular to the plane of the drawing—as indicated by the concentric circles. A structured retardation film (structured half-wavelength plate) with polarizing regions PE1 is arranged on the shutter display S. The polarizing regions PE1 are designed in such a way that they act on the pixels of the shutter display S, which are assigned to the respective lenses of the lenticular system L, to be precise in such a way that they are only provided—in periodic continuation—at every second lens L2, L4, . . . . The polarizing regions PE1 are also designed in such a way that they rotate the linearly polarized light from the illumination arrangement BL by 90° such that the linearly polarized light, then present, oscillates in the plane of the drawing. Arranged on the side of the lenticular system L facing the shutter display S is a further structured retardation film (structured half-wavelength plate) with polarizing regions PE2, which are designed in such a way that they rotate the linearly polarized light by 90°. A linear polarizer LP, which only passes light polarized linearly and perpendicularly with respect to the plane of the drawing, is arranged behind the lenticular system L. Since the dimensions of the further polarizing regions PE2 correspond to the dimensions of the individual lenses of the lenticular system L in this exemplary embodiment, crosstalk can be avoided.

Two pixels Pi1, Pi2 are switched to be transmissive in the upper region of the shutter display S. Accordingly, linearly polarized light can pass the two pixels Pit, Pi2 of the shutter display S, said light then being collimated by the uppermost lens L1 shown in FIG. 11. The light coming from these two pixels Pit, Pi2 can pass the linear polarizer LP even after collimation by the lens L1. Light impinging on the further polarizing region PE2 of the structured retardation film assigned to the lens L2 is rotated by 90° and, although it can pass the lens L2, it is blocked by the linear polarizer LP.

The linearly polarized light, which passes through the two pixels Pi3, Pi4, which are switched to be transmissive, assigned to the lens L2 and depicted further down, is rotated by 90° in terms of its polarization direction. This is indicated by the double-headed arrow, which is shown between the two regions PE1, PE2. The polarizing region PE2 of the structured retardation film rotates the polarization of the light coming from the polarizing region PE1 by 90°such that the light is linearly polarized and oriented perpendicular to the plane of the drawing, and able to pass through the lenticular system L and the second lens L2. Accordingly, the light coming from the polarizing region PE1, which also passed through the polarizing region PE2, can now—after two-fold rotation of the linear polarization—pass the linear polarizer LP. Light coming from the polarizing region PE1, which has not passed through the polarizing region PE2, is still linearly polarized in the horizontal direction and cannot pass the linear polarizer LP.

However, the advantageously adapted use of structured retardation elements (retarders), such as e.g. structured birefringent layers, renders it possible to achieve a reduction in the number of polarization filters used in the suppression of crosstalk in autostereoscopic displays. The function of suppressing interfering light is completely maintained while increasing the overall transmission by a factor between >2 and approximately 4.

The advantageous rotation of the polarization of the light increases the overall transmission by a factor >2. Since standard polarization films only have a transmission of e.g. 0.7, even for the transmitted polarization, this results in a realistic factor of between 3 and 4 for the light power that is saved.

This means a reduction in the required light power by a factor between 3 and 4, and therefore a power intake of the illumination unit which is reduced by a factor between 3 and 4 in the operation of the autostereoscopic or holographic display appliance.

DE 10 2006 033 548 A1 describes the use of two analyzer strips per lens of a lenticular array L, i.e., for example, per lens of a cylinder lens array. Here, one strip of a transmission polarization is arranged in the plane of the controllable light source centers of the light source array LS-A and a second strip with the same transmission polarization is arranged in front of the associated lens of the cylinder lens array CL. The transmission polarization of the two strips adjacent in the plane of the controllable light source centers of the light source array LS-A and strips of a polarization film adjacent in the plane of the cylinder lenses CL is orthogonal to the transmission polarization of the respectively included strip of a polarization film.

Structured retardation elements, i.e. retardation elements comprising birefringent or polarization-rotating regions, can be used to combine effective suppression of crosstalk with increased transmission through the display. The principle is depicted in FIG. 12, which shows the use of two birefringent half-wavelength strips and a strip-shape analyzer in front of every second lens of the lenticular array L.

Here, N/2 polarization film strips are used for a field of N cylinder lenses (1D cylinder lens grid, also lens grid or lenticular system). In comparison thereto, in DE 10 2006 033 548 A1, there are 2N, i.e. 4×as many.

In the following text, the embodiment proposed here is compared to the embodiment from DE 10 2006 033 548 A1 on the basis of a calculation, wherein, in the first case, a transmission of the polarization film for the intended polarization of 70% is assumed and, in the second case, a transmission of the polarization film for the intended polarization of 80% is assumed.

Case 1: 70% transmission of the polarization film for the intended polarization

An increase in the overall transmission by a factor of approximately 3.5 emerges from

(0.5×1+0.5×0.7)/(0.5×(0.5×0.7²+0.5×0.7²))=0.85/0.245

when using standard polarization film strips with 70% transmission for the intended polarization.

Case 2: 80% transmission of the polarization film for the intended polarization

In the case of very good and, compared to standard polarization film strips, significantly more expensive polarization film strips, which have 80% transmission for the intended polarization, an increase in the overall transmission by a factor of more than 2.8 emerges from

(0.5×1+0.5×0.8)/(0.5×(0.5×0.8²+0.5×0.8²))=0.9/0.32.

The increase in the overall transmission is very clear in both cases. On average, a factor of approximately 3 is achieved.

The arrangement of strip-shaped retardation elements within a component used for light source tracking can be used both for autostereoscopic and for holographic display appliances.

A number of 1D or 2D permutations are possible in respect of the lens grid and the light source grid, and hence also of the retardation film strip grid and the polarization film strip grid. The following lists examples for 1D lens arrays:

1D cylinder lens: lens grid and light source centers equidistant

1D cylinder lens: lens grid equidistant and light source centers increasing toward the outside in order to approximate the function of a 1D field lens 1D FL

1D cylinder lens: lens grid decreasing toward the outside and constant light source centers in order to approximate the function of a 1D field lens

1D cylinder lens: lens grid decreasing toward the outside and light source centers increasing toward the outside in order to approximate the function of a 1D field lens

These permutations can also be implemented for the case where a 2D lens grid, and hence a 2D light source array, a 2D retardation element segment grid and a 2D polarizer segment grid, is used, for example for implementing the function of a field lens.

There are a number of embodiments for the use of structured retardation elements within an arrangement for suppressing light source crosstalk, of which some embodiments are illustrated in an exemplary manner in the following within an arrangement for suppressing light source crosstalk, which arrangement is part of the display device according to the invention.

FIG. 13 shows an embodiment in which the primary light wave field pLF impinges on a shutter display S. Consequently, it satisfies the function of a light source array LS-A, which can be locally switched on and off in a controlled manner. By way of example, the shutter display S can be an array of centers which can be switched in terms of transmission. However, on the other hand, the shutter display S can also be an array of self-luminous centers, e.g. an OLED matrix.

Arranged behind the light source array or—in the case of the illumination arrangement BL/shutter display S variant—in front thereof, is a spatially structured first birefringent element sR1 as first structured retardation element. Thus, a polarization matrix is, in a spatially structured manner, impressed upon the light wave field in the light source plane. The embodiment depends on the light source array LS-A. In the case of a self-luminous light source array, the arrangement depends on the polarization of the light source array LS-A.

Arranging, e.g. in the plane sR1, a spatially structured analyzer matrix, which is repeated in the plane of the cylinder lenses CL, lends itself as light source array LS-A in the case of an OLED (organic light-emitting diode) display. However, use can also be made of a first unstructured analyzer plane and a structured retardation element plane behind an OLED display in the plane sR1. A second structured retardation element, e.g. a spatially structured second birefringent element, and an unstructured analyzer plane A, in this case as an alternative for a structured analyzer, can be used in a second plane sR2.

The structured retardation elements of the planes sR1 and sR2 can lie opposite one another. If, in the plane sR2, the second analyzer is orthogonal with respect to the first analyzer of the plane sR1, the structured retardation elements of the planes sR1 and sR2 do not lie opposite one another. The emerging light wave field sLF, present behind the cylinder lenses CL, is free from light source crosstalk, but still orthogonally polarized in a structured manner. A further, third plane of a structured retardation element can be used if it is advantageous for the subsequent components to have an unchanging polarization in the emerging light wave field sLF.

In the case of a transmission light source array, an unstructured analyzer can e.g. be attached in front thereof, or therebehind, but said unstructured analyzer is dispensed with if the light emerging from an illumination arrangement BL in the direction of the transmission light source array is already polarized. By way of example, this can be the case if a planar optical waveguide and a decoupling volume grating are used in the illumination arrangement BL.

In the case of output polarization present in a planar defined manner, it is sufficient to arrange a single structured birefringent layer in the plane sR1, by means of which layer a structured impression of mutually orthogonal polarizations is introduced.

By way of example a structured birefringent layer can consist of polymerized liquid crystals LC having orientation. The orientation of the corresponding molecules can for example be brought about by surface alignment (“photo alignment”) or by direct orientation of the molecules depending on the polarization of an incident radiation.

In the case where polymerized liquid crystals are used, the selection of molecules or the selection of the mixture of molecules has to be made in such a way that the introduced birefringence, or the introduced polarization rotation, for the employed reconstruction wavelengths is as similar as possible, i.e. that apochromatism of the spatially structured, introduced function is given to the greatest possible extent.

In order to achieve sufficient apochromatism, a plurality of structured birefringent layers can also, in each case, be placed one above the other in the plane of the first or second structured retardation element sR1 or sR2.

Since, in general, chromatic aberrations increase with increasing refractive power and with increasing birefringence, it is advantageous to symmetrize the spatially structured, introduced birefringence. That is to say, for example, it is advantageous in the case of spatially alternating birefringence to introduce −λ/4, +λ/4, −λ/4, +λ/4, . . . instead of 0, λ/2, 0, λ/2, . . . . This can, in general, be used both for a spatially structured impression of light (TE, TM, TE, TM, . . . ) with mutually perpendicular linear polarization in a plane perpendicular to the propagation direction of the light and for a spatially structured impression of left-hand and right-hand circularly polarized light (LHC, RHC, LHC, RHC, . . . ). The symmetrization of spatially structured, introduced birefringence is advantageous in the planes sR1, sR2 and in optional further planes.

The light which illuminates the shutter display D or, in the case of a self-luminous light source array LS-A, emerges from said light source array LS-A, can, for example, be circularly polarized or else be linearly polarized. A first polarization rotation, introduced in the plane sR1 by e.g. −λ/4, +λ/4, −λ/4, +λ/4, . . . , and a second polarization rotation, introduced in the plane sR2 by e.g. −λ/4, +λ/4, −λ/4, +λ/4, . . . , then, overall, leads to orthogonal polarization states of the zones of adjacent light source centers behind the plane sR2, i.e. to orthogonal polarization states of the light assigned to adjacent cylinder lenses CL if the assigned, i.e. the correct, regions were not passed through. As FIG. 15 shows, the light assigned to adjacent collimation lenses CL, which light passes through the assigned region as intended, is polarized in the same manner in front of the analyzer A. When passing into a directly adjacent region, there is a polarization in front of the analyzer A which is blocked by the latter.

Spatially structured orthogonal polarizations can be queried by spatially structured analyzers. As depicted in FIG. 13, the analyzer A can be designed in a planar, unstructured manner. However, it need not lie in front of the cylinder lens field L. By way of example, use can be made of an analyzer A lying on the input side of the data display D, or lying in the following planes. The arrangement from FIG. 13 is preferable since symmetrized birefringent structures generally enable an improved apochromatism with respect to the phase retardations introduced for three reconstruction wavelengths. In this arrangement, a polarization-dependent phase retardation is introduced for, in each case, all adjacent regions which are assigned to the width of a cylinder lens CL or lens.

The change in polarization introduced segment-by-segment in a first plane sR1 is either revised in a second plane sR2 or, for example, a further phase rotation is applied thereto. By way of example, a possible polarization sequence is TE12|LHC1, RHC2|TE12 (also: TE1, TE2|LHC1, RHC2|TE1, TE2, also: LQ-TE|TE-1, TE2|LHC1, RHC2|TE1, TE2|A-TE). There are a number of further possible polarization sequences.

FIG. 14 depicts the two-fold introduction (once in the plane of the first structured retardation element sR1 and once in the plane of the second structured retardation element sR2) of a phase rotation for every second cylinder lens CL or lens. Possible polarization states present in the individual planes, i.e. from the primary light wave field pLF to the emerging light wave field sLF, are those which provide orthogonal polarizations between the planes of the first structured retardation element sR1 and the second structured retardation element sR2. Therefore, it is possible to select a number of possible combinations.

The combination LQ-TE|TE1, TE2|TE1, TM2|TE1, TE2|A-TE, or else LQ-TE|TE1, TE2|TE1×TM2|TE1, TE2|A-TE, is depicted in FIG. 15. Polarization orthogonality is also given in the region between the output plane of the controllable light source array LS-A and the collimating cylinder lenses CL by |LHC1×RHC2|, from which possible arrangements of segmented birefringent structures emerge. Here, these segmented birefringent regions do not have a symmetrical design with respect to the introduced phase shift in this example.

For illustrative purposes, the structured retardation element was slightly removed from the lenticular system L (lens array). The smallest possible distance therefrom is advantageous.

|TE1×TM2| and |LHC1×RHC2| can each be realized by a plurality of arrangements, wherein, in general, symmetric arrangements are preferred due to smaller chromatic phase errors.

By way of example, possible polarization sequences are:

LQ-TE|TE1, TE2|TE1×TM2|TE1, TE2|A-TE, not symmetrized
LQ-TE|TE1, TE2|TE1×TM2|TM1, TM2|A-TM, symmetrized with sR1 and sR2
LQ-TE|TE1, TE2|LHC1×RHC2|TE1, TE2|A-TE, separately symmetrized in sR1 and sR2
LQ-LHC|LHC1, LHC2|TE1×TM2|LHC1, LHC2|A-LHC, separately symmetrized in sR1 and sR2
LQ-LHC|LHC1, LHC2|TE1×TM2|RHC1, RHC2|A-RHC, separately symmetrized in sR1 and sR2.

By way of example, a rotated linear polarization, that is to say e.g. TE-45°, can also be a possible input polarization. In general, slight changes in the polarization state of the primary light wave field pLF can be used to achieve intensity balancing in differently polarized channels.

Since a liquid crystal data display D generally requires a defined input polarization and therefore usually has an analyzer on the input side thereof, it is advantageous to bring possible polarization sequences in line therewith, i.e. adapt these accordingly and avoid the analyzer A attached in front of the lenticular system L.

When using lenses, an apodization can advantageously be used to compensate intensity variations introduced by the lens grid. The apodization usually applied in the vicinity of the lenses can, for example, be a grayscale value distribution, or else a color filter distribution separated into red R, green G and blue B. A color filter distribution separated into red R, green G and blue B lends itself if the grayscale value distributions optimized for the individual wavelengths are sufficiently different. By way of example, grayscale value distribution and color filter distributions separated into red R, green G and blue B can be produced inexpensively by exposing a photographic material. In the process, it is also possible to select a distribution which is individualized in respect of individual appliances, wherein e.g. it is also possible to use e.g. calibration data of illumination arrangement BL, optionally also in conjunction with calibration data of the lenticular system L or else of all other relevant components used in the display appliance.

In addition to grayscale value distributions and color filter distributions separated into red R, green G and blue B, an apodization can also be achieved by means of a spatially structured distribution of the polarization state. By way of example, it is suggestive to deviate from a segmented binary birefringence in the plane of the second structured retardation element sR2 of an arrangement, which is symmetrized in each plane with respect to the present birefringence, and to select an albeit segmented distribution of the birefringence in such a way that e.g. lens edges that appear darker are compensated by virtue of the fact that the birefringence introduced into the central region of the individual lenses correspondingly deviates from the birefringence which would enable the maximum transmission through an analyzer e.g. following in the input plane of the data display D (also referred to as image SLM). Therefore, the intensity perceivable by the observer O in the center of the lenses is reduced in such a way that the lens edges appear with the same brightness as the central regions of the lenses.

The suppression of the visibility of the lens grid can also be brought about by means of the data display D. Here, static data, that is to say e.g. calibration data of the tracking unit or else data from the optical simulation, can be used in a first step.

Apodization distributions, to be introduced on average over the tracking region, can e.g. be fixedly implemented in color filter distributions separated into red R, green G and blue B and polarization state distributions by means of grayscale value distributions—without in the process reducing the bit-depth of the data display D which is available for depicted images.

A dynamic implementation can be achieved by means of the data display D. However, it is necessary, to this end, to have data from the optical simulation and/or data from the calibration for the angles of the tracking; i.e., to take said data into account, for example by means of a table of stored correction values.

By determining the eye position of the user, the associated angles in space, i.e. the angles, which are to be set locally by the display appliance or are present, the intensity distributions, which are known from the optical simulation or from e.g. the calibration undertaken in the factory, of the lenticular system L and hence the correction values to be set by the data display D emerge. The correction values depending on the positions of the individual eyes of the observer or observers O can be applied sequentially in time to the data display D.

When using additionally attached fixed solid angle multiplexing prism structures, these themselves lead to spatial variations in the intensity distribution. The correction values, for example written into the data display D in addition to the image content, advantageously consider the entire volume in which a user of an autostereoscopic or holographic display device can be, i.e. the whole region of the tracking of the image information. In a simple case, the subdivision of the solid angle multiplexing prism structures is symmetrical.

Therefore, in the simplest case of a strip-shaped alternating subdivision of the deflection angles of the prism segments Pr1, . . . Prn (prism cells) and strip-shaped cylinder lenses CL, this results in a strip-shaped assignment of apodization correction values, which can e.g. be applied to the data display D. For one eye position, what emerges in the process is a one-dimensional correction vector for the whole (3D) display device. If the shading perceivable by the observer O locally on the display device is, for example, only dependent on the horizontal eye position and not, or not in a sufficiently extensive manner, dependent on the vertical eye position, this results in a set of one-dimensional correction vectors, i.e. a 2D correction matrix for the whole (3D) display device.

The display device can realize a fixed multiplexing prism function, for example by the spatial multiplexing of surface relief prisms, but also by the spatial multiplexing of gradient index prisms. Therefore, multiplexing of fixed field lens functions can be implemented in 3D display devices.

In autostereoscopic and holographic display devices, a spatial light modulator SLM can comprise apodization corrections for strip-shaped solid angle multiplexing prism structures and for matrix-shaped solid angle multiplexing prism structures, wherein these multiplexing prism structures for example can be used to extend the region of tracking or for realizing a plurality of field lens functions which are tilted with respect to one another and nested within one another. Field lens functions nested within one another correspond to the nesting of lens and wedge functions.

If use is made of a plurality of refractive surfaces arranged obliquely to the incident beam, the interface with the largest refractive power lies as close as possible to the output plane in order to minimize possible truncation of the light beam.

Examples of some possible implementations of fixed solid angle multiplexing prism structures are depicted in FIG. 16. It enables the nesting of a plurality of prisms and planarization of the surfaces of fixed solid angle multiplexing prism structures, similar to the ones used in WO 2010/066700 A2.

In autostereoscopic display appliances, it is also possible to attach fixed and switchable scattering films in the vicinity of fixed solid angle multiplexing prism structures in order to achieve an optimization of the visibility region.

As an alternative to the display sequentially in time, spatial multiplexing can be used to generate the locally varying emission angles. In the case of an angle resolution of 1/60° of the human eye under ideal conditions—this results in a pixel size of 290 μm, corresponding to the resolution, in the case of observer distance of 1 m. For spatial 2×multiplexing in the horizontal direction of an autostereoscopic display, this therefore results in a pixel size of 145 μm if an observer distance of 1 m is assumed and a pixel size of 109 μm if an observer distance of 750 mm is assumed.

The period of the spatial structuring of the prism film, for example to be applied over a scattering film, is Λ_{P}>100 μm. This prism structure, which corresponds to two nested off-axis 1D Fresnel lenses, can be produced e.g. by molding from a master. Arranging the scattering layer behind the prism mask is the favored embodiment.

The implementation of a mean field lens function and mean off-axis field lens function reduces the angles to be applied by the illumination—for example when using light source tracking—and hence reduces the aberrations generated during light source tracking, which, in general, increase with larger angles.

The transitions between individual surfaces of the multiplexing prism arrays likewise constitute a source of interfering light. This interfering light, i.e. this interfering crosstalk, can be reduced by the use of amplitude aperture masks, which are attached directly in front of the transitions of the multiplexing prisms, directly on these or else directly behind these. This additional aperture arrangement BA is depicted in FIGS. 17a and 17b. FIG. 17b moreover depicts that it is possible to use microlenses ML in order to increase the transmission through the prism plane. Here, the proportion of the light which is absorbed on the aperture arrangement BA is reduced. FIG. 17c shows that it is also possible to dispense with apertures but nevertheless avoid illumination of the prism edges.

The apodization of the transition regions of the solid angle multiplexing prisms can, for example, be designed in binary form or else in the form of a grayscale value profile.

Suppression of crosstalk between fixed prism segments can also be achieved by sidewalls which e.g. are configured to be absorbent.

The suppression of crosstalk of adjacent regions while maximizing the overall transmission, proposed here, can likewise be introduced for the plane of the solid angle multiplexing prisms.

The pixels (i.e. the image points of the data SLM or data display D), which are assigned to the prism segments, can alternately also have structured retardation elements arranged therebefore or therebehind in order to impress an alternating intended polarization thereupon, that is to say e.g. TE-TM-TE- . . . etc. or LHC-RHC-LHC- . . . etc. (TE: transverse electric; TM: transverse magnetic; LHC: left-hand circular; RHC right-hand circular).

Here, it is possible to work only with structured polarizers, which, although it prevents crosstalk between solid angle multiplexing prisms, it does not constitute the preferred embodiment in respect of the increase of the overall transmission.

Here, the preferred embodiment is the minimized use of polarizers. Structured retardation elements or structured retardation elements/analyzer combinations are alternately arranged in front of or behind the prism surfaces.

The symmetrization of the spatially structured, introduced birefringence is also advantageous in this case. Possible polarization states emerge analogously to the embodiments for suppressing LQ-crosstalk.

The emission angle or the emission characteristic of the light sources of the light source array LS-A with respect to the lenticular system L must be so large that a lens of the lenticular system L is illuminated over its entire surface by a light source of the light source array LS-A.

If the light source array LS-A comprises an illumination arrangement BL and a shutter display S, this emission angle of the light source, i.e. in this case a shutter opening S1 . . . Sn, is thus generated by the illumination arrangement BL illuminating the shutter display S, possibly by scattering components of the shutter display S or in part also by diffraction of the shutter openings S1 . . . Sn.

If the light source array is a self-luminous display, the emission angle is thus generated by the setup of the light sources themselves or by possibly scattering components in front of the light sources.

The condition of complete illumination of the lens must be set for all positions of the shutter openings Sn behind a lens required for the light source tracking, or for all light sources of a self-luminous display as light source array LS-A.

The shutter openings Sn or the light sources of a self-luminous display usually have a symmetric emission angle.

For shutter openings Sn or light sources of a self-luminous display, which are laterally displaced to the lens center or to the optical axis of the lens, this means that the emission angle has to be selected to be larger than corresponding to the angle of the shutter display S or of the self-luminous display in relation to the width of a lens.

FIG. 18 shows this schematically using the example of a shutter display S. A shutter opening S1, which can be realized by a transparent pixel of the shutter display S, is intended to guide light through a lens L1 in the direction of a detected observer position. The emission angle (angle between the emboldened lines) must be so large that at least the upper edge of the lens L1 is reached. However, in the case of a symmetric emission, this means that part of the light impinges on the lens L2. However, this part is not required for the light source tracking. Although it can be blocked, this corresponds to a light loss in the system, i.e. a disadvantageous light efficiency.

It is therefore more advantageous to place prism elements PriEl or lenses LiEl in the direct vicinity of the shutter openings S1, . . . Sn or of the light sources of a self-luminous display, which prism elements or lenses guide the light from the shutter openings Sn or the light sources of the self-luminous display in the direction of the center of the respective lenses of the lenticular system L. This is shown schematically in FIGS. 19 and 20.

Using the example of a shutter display S, FIG. 19 shows lenses CL in front of the shutter openings Sn. In the preferred embodiment, the focal length of these lenses CL corresponds to approximately the distance between the shutter display S and lenticular system L. Using the example of a shutter display S, FIG. 20 shows the embodiment of the solution with prism elements PriEl. A prism in front of each shutter opening S1 . . . Sn guides the light to the center of the lens L1 of the lenticular system L.

Then, a smaller emission angle of the shutter openings S1, . . . Sn or of the light sources of a self-luminous display is required for illuminating the desired lens L1 of the lenticular system L.

In the case of a light source array LS-A which comprises an illumination arrangement and a shutter display S, this smaller emission angle can be generated by virtue of e.g. the properties of the illumination arrangement BL or of a scattering member in, or on, the shutter display S being adapted.

In the case of a light source array LS-A which comprises a self-luminous display, it is possible, for example, to adapt the properties of the light sources themselves or of a scattering member.

Therefore, using the smaller or adapted emission angle, an improved efficiency of light intensity in the illumination arrangement BL is achieved relative to the light intensity directed in the direction of the detected observer position. In general, the aforementioned prisms and lenses can be configured either as refractive or as diffractive elements.

The use of microlenses with a very short focal length, in front of the image points of the data display D also lends itself to light source tracking. A precondition is a focal length of the microlenses which emerges from the greatest angle introduced by the light source tracking. In order to increase the angle range which is to be propagated by individual pixels, a reduction in the focal length of the microlenses situated directly in front of the individual pixels of the data display D is necessary. Hence, it is possible not to illuminate the region present between the pixels Pn. This increases the transmission through the data display D. As a result of the non-illumination of the transition region present between the pixels Pn, it is possible, especially in the case of a holographic display device, to avoid locally erroneous phase values, so-called fringe fields. These transition regions interfering with the holographic reconstruction of object points can be optically masked by the use of microlenses, wherein a purely absorbing amplitude mask is avoided and therefore the overall transmission is increased.

Microlenses can also be used in other planes in order to increase the transmission. The arrangement of the microlenses ML in front of prisms which are arranged behind the image points of the data display D is shown in FIG. 17.

The use of birefringent solid angle multiplexing prisms renders it possible to undertake switching between implemented advance deflections by switching between polarization states. To this end, use can be made, for example, of a fast-switching λ/2 liquid crystal surface, as is used e.g. in stereo display appliances, in order to switch between the polarizations which are transmitted by the left-hand or right-hand analyzer of the glasses, that is to say e.g. between TE and TM or LHC and RHC.

This procedure can be used for large angles, or else for small angles, such as e.g. the angle between two eyes.

Advantageously, use can be made of polymerized liquid crystals in order to generate differences in the refractive index and hence in the deflection angle of the birefringent prism structures, which are present for the different polarizations or between which it is possible to switch to and fro. An example for generating a birefringent prism structure lies in the generation of a prism structure, into which a liquid crystal which is subsequently polymerized is embedded. In order to orient the liquid crystals, use can be made of e.g. a surface alignment generated by brushing or exposure, or else an alignment by means of exposing and aligning the liquid crystals or other molecules, preferably perpendicular or parallel to the input polarization. In industry, very fine brushes, which have the form of a roller, are used for brushing liquid crystal alignment surfaces.

It is also possible to generate a first birefringent prism structure, into which a second birefringent prism structure which, however, has different orientation of the principal axis of the refractive index ellipsoid is embedded.

The birefringent prism structures can be placed next to one another and can be nested. Within the meaning of the number of the pixels of a data display (data SLM) to be used, the nesting of birefringent prism structures is advantageous. When nesting, the orientation of the principal axes of the refractive index ellipsoid of the separate prisms can be arranged e.g. analogously to the Rochon beam splitter, the Sénarmont beam splitter or the Wollaston polarization beam splitter. Here, nesting means that e.g. a plurality of prism structures are arranged one above the other. By way of example, it is also possible to place three birefringent or two birefringent prism structures, and one non-birefringent prism, over one another.

Here, an arrangement of three prism structures can be used to increase the effective fill-factor of the output plane compared to an arrangement of two prism structures arranged one above the other, and therefore reduce the diffractive angle of the individual pixel aperture, that is to say receive more light in the entry pupil of the observer eye.

In general, this applies to deflecting prisms, i.e. also to solid angle multiplexing prisms, which consist of materials with a spherically symmetric refractive index ellipsoid, that is to say of an isotropic material.

Behind a light source tracking unit, use can be made of solid angle multiplexing gratings in order to increase the overall angle region of the tracking. These arrangements can be used for autostereoscopic displays and for holographic displays.

By way of example, use can be made of thin, switchable volume gratings which each produce an additional, freely selectable additional deflection angle which e.g. can be varied by ±15° in sufficiently fine angle gradations by means of a light source tracking unit. Switching on and off, that is to say the slight reorientation of liquid crystals embedded in volume grating matrices, is brought about by planar, sufficiently transparent electrodes.

By way of example, use can be made of switchable liquid crystal surface relief gratings, which each produce an additional, freely selectable additional deflection angle which e.g. can be varied by ±25° in sufficiently fine angle gradations by means of a light source tracking unit. Switching on and off, that is to say the reorientation of liquid crystals embedded in surface relief structures, is brought about by planar, sufficiently transparent electrodes.

By way of example, use can be made of planar switchable polarization liquid crystal gratings, which each generate an additional, freely selectable additional deflection angle which e.g. can be varied by ±35° in sufficiently fine angle gradations by means of a light source tracking unit. The additional angles are switched on and off by switching retardation plates on and off, which retardation plates can be switched over an area, that is to say with at least one polarization switch which can be switched over an area. By way of example, in this case, switching between the LHC, TE and RHC polarizations corresponds to switching between the angles of 35°, 0° and −35°. One or more polarizers, which can be switched over an area, can optionally be arranged behind this arrangement in order to block the interfering zeroth order of diffraction.

Polymerized polarization gratings can be used in conjunction with planar polarization switching, wherein the full resolution of the data display D can be employed for the therefore three angles which can be selectively added. By way of example, polymerized polarization gratings have a substantially increased angle selectivity compared to volume gratings, and so they can be illuminated e.g. by an angle range, equaling ±15°, which is generated by a light source tracking unit, wherein, at the same time, high diffraction effectiveness is achieved.

By way of example, segmented birefringent regions and segmented polymerized polarization gratings can be attached behind a data display D. By switching on individual pixels P1 . . . Pn of the data display D, or by selecting segments of the data display D, spatially segmented polarization states are generated, spatially segmented, or else spatially non-segmented, polarization gratings are illuminated and hence spatially segmented diffraction angles (multiplexing angles) are selected. However, the required resolution of the data display D increases here with the number of angles implemented in the solid angle multiplexing element. By way of example, multiplexing can also take place with respect to the colors.

The segmented, or else non-segmented, selection of multiplexing functions can, for example, take place using surface relief prism structures, refractive index gradient prism structures, polarization prism structures, assembled prism structures lying one behind the other, which for example consist of 2 or 3 sub-prisms arranged one behind the other and e.g. are also planarized, polarization gratings, volume gratings and surface relief gratings. In general, the number of implementable multiplexing functions in this case is restricted by the resolution available in the data display D.

The aspects described here can, for example, be used for autostereoscopic display devices and holographic display devices, wherein the tracking can take place in one dimension (1D) or in two dimensions (2D) and the encoding can also be one-dimensional (1D) or two-dimensional (2D) in the case of holographic display appliances. It is possible to achieve an increase in the overall transmission and a reduction of interfering light, i.e. light reducing the image quality.

Finally, reference is made, in particular, to the fact that the exemplary embodiments explained above merely serve to describe the claimed teaching but the latter is not restricted to said exemplary embodiments. In particular, the above-described exemplary embodiments could—to the extent that this is possible—be combined with one another.

1. A display device for representing a three-dimensional scene, comprising a light source array, a lenticular system and a data display in this order, but not necessarily immediately following one another, characterized by a multiplexing element, which follows the data display and is usable to distribute light incident from the data display into a plurality of angle segments.

2. The display device as claimed in claim 1, wherein the light source array comprises an illumination arrangement and a shutter display or the light source array comprises a self-luminous display, in particular, an OLED display.

3. (canceled)

4. The display device as claimed in claim 1, wherein it comprises means for determining a visibility region.

5. The display device as claimed in claim 1, wherein it comprises an autostereoscopic 3D display or a holographic 3D display.

6. (canceled)

7. The display device as claimed in claim 1, wherein a field lens is arranged following the multiplexing element or between the lenticular system and data display.

8. The display device as claimed in claim 1, wherein the data display comprises pixels and the multiplexing element comprises segments, the segments of the multiplexing element being matched to the pixels of the data display.

9. The display device as claimed in claim 1, wherein the data display comprises color filters for the primary colors, arranged pixel-by-pixel, and the segments of the multiplexing element corresponding thereto are each designed to refract in a wavelength-dependent manner.

10. The display device as claimed in claim 1, wherein the multiplexing element comprises a prism mask, which comprises a row-by-row and/or column-by-column periodic arrangement of prism segments.

11. The display device as claimed in claim 10, wherein the prism segments of the prism mask of the multiplexing element comprises a plurality of refractive surfaces with different refractive powers, arranged at an angle greater than 0° and less than 90° with respect to the optical axis.

12. The display device as claimed in claim 10, wherein the data display comprises color filters for the primary colors, arranged pixel-by-pixel, and the corresponding prism segments of the prism mask comprise prism angles adapted to their wavelength-dependent refractive index.

13. The display device as claimed in claim 1, comprising an arrangement of light-polarizing elements.

14. The display device as claimed in claim 13, wherein the arrangement of light-polarizing elements is linked to at least two of the following three elements: light source array, lenticular system and data display.

15. The display device as claimed in claim 13, wherein the arrangement of light-polarizing elements comprises structured polarization filters and/or structured retardation elements, the structured polarization filters and/or structured retardation elements preferably arranged and designed in such a way that crosstalk is largely avoidable.

16. (canceled)

17. The display device as claimed in claim 15, wherein the structured retardation elements comprise birefringent and/or polarization-rotating regions, the birefringence of structured retardation elements preferably being symmetrized.

18. The display device as claimed in claim 13, wherein the light-polarizing elements are configured in such a way that they comprise a plurality of polarizing sub-elements arranged one above the other.

19. (canceled)

20. The display device as claimed in claim 1 comprising at least one apodization means.

21. The display device as claimed in claim 20, wherein the apodization means comprises a grayscale distribution or a color distribution separated into red/green/blue or a spatial distribution of the polarization state, and/or the apodization means is implemented in the data display.

22. (canceled)

23. The display device as claimed in claim 20, wherein the data display comprises pixels and contains non-illuminated transition regions between the pixels of the data display.

24. The display device as claimed in claim 1 comprising an additional, controllable deflection element that can be introduced into the beam path.

25. The display device as claimed in claim 24, wherein the additional, controllable deflection element comprises liquid crystals embedded in switchable volume grating matrices and transparent electrodes, or switchable liquid crystal surface relief grating and transparent electrodes, or switchable liquid crystal polarization gratings as switchable retardation plates.

26-27. (canceled)

28. The display device as claimed in claim 1, wherein optical elements are arranged on the light-output side of the light source array, by means of which optical elements the light from the light source array in each case can be guided to the center of a lens of the lenticular system.

29. The display device as claimed in claim 28, wherein the optical elements comprise lenses, the focal length of which corresponds to the distance between the light source array and lenticular system, or the optical elements comprise prisms.

30. (canceled)

31. The display device as claimed in claim 1, wherein it comprises microlenses in front of the multiplexing element and/or an aperture arrangement in front of or directly behind the multiplexing element.

32. A method for representing a three-dimensional scene, wherein light is emitted from a light source array depending on a visibility region defined by the position of an observer, guided through a lenticular system onto a data display, the data display controlling the transmission of this light in terms of phase and/or amplitude in a pixel-by-pixel manner and the modified light finally being perceived by an observer in visibility regions assigned to his eyes, characterized in that a multiplexing element distributes the light coming from the data display in a plurality of angle segments.

33. The method as claimed in claim 32, wherein that the light source array contains an illumination arrangement, from which a homogeneous light wave field emerges and subsequently passes activated pixels of a shutter display depending on a visibility region defined by the position of an observer, or a self-luminous display, in particular an OLED display, emits light from activated pixels of this display depending on a visibility region defined by the position of an observer.

34. (canceled)

35. The method as claimed in claim 32, wherein the light is sequentially guided to the individual angle segments, wherein always only one angle segment is illuminated at any one time.

36. The method as claimed in claim 32, wherein the visibility region within one angle segment is tracked by means of light source tracking, preferably that the visibility region within an angle segment is tracked sequentially in time.

37. (canceled)

38. The method as claimed in claim 32, wherein the light passes through a field lens on its path from the light source array to the observer.

39. The method as claimed in claim 32, wherein, in pre-definable spatial regions, light experiences a change in the polarity thereof on the path from the light source array to the observer.

40. The method as claimed in claim 32, wherein there is apodization, and the apodization is preferably sequential in time for different eye positions.

41. (canceled)

42. The method as claimed in claim 32, wherein the light is additionally deflected by a controllable deflection element that can be introduced into the beam path, preferably that an additional deflection is produced by the reorientation of liquid crystals contained in a volume grating or in a liquid crystal surface relief grating or in a liquid crystal polarization grating, which liquid crystals are part of a controllable deflection element.

43. (canceled)
